(19) United States
(12) Patent Application Publication
(10) Pub. No.: US 2002/0010861 A1
(43) Pub. Date: Jan. 24, 2002

(54) Access control system, access control method, device, access control server, access-control-server registration server, data processing apparatus, and program storage medium

(76) Inventors: Shinako Matsuyama, Tokyo (JP); Yoshihito Ishibashi, Tokyo (JP); Ichiro Futamura, Kanagawa (JP); Masashi Kon, Kanagawa (JP); Hideaki Watanabe, Tokyo (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/843,403

(22) Filed: Apr. 26, 2001

(30) Foreign Application Priority Data
Apr. 26, 2000 (JP) P2000-125787
Mar. 27, 2001 (JP) P2001-089672

(51) Int. Cl. H04L 9/00

(52) U.S. Cl. 713/182; 713/161; 713/165; 713/166

(57) ABSTRACT

An access control system, which eliminates the necessity for access controls to be performed by individual service providers, has an access control server which is used commonly by a plurality of service providers and devices. The access control server issues access permissions in accordance with predetermined format and procedure. Access control is executed in accordance with the access permission, so that each service provider and each device can easily execute the access control without building up their own access control procedures. A user device which receives the services from various service providers is not required to execute different access control sequences for different service providers, and can execute the access control in accordance with a predetermined sequence. Thus, the user device need not store and administrate different format data and access programs for different service providers.

### RELATED APPLICATION DATA

The present application claims priority to Japanese Application No. P2000-125787 filed Apr. 26, 2000, and P2001-089672 filed Mar. 27, 2001, which applications are incorporated herein by reference to the extent permitted by law.

### BACKGROUND OF THE INVENTION

The present invention relates to an access control system, an access control method, and a device, and further to an access control server, an access-control-server registration server, a data processing apparatus and a program storage medium. More particularly, the present invention is concerned with an access control system which performs controls on accesses from user devices to various service providers requesting services provided by the service providers. Still more particularly, the present invention is directed to an access control system suitable for use in a data communication system which executes transfer of data between entities upon execution of mutual authentication of the entities based on public key certificates possessed by these entities.

Nowadays, a variety of software data such as game programs, acoustic data, image data, documentation programs and so forth (collectively referred to as a “content” hereinafter) are distributed through the internet or other networks. At the same time, merchandize through networks, e.g., so-called on-line shopping, is becoming popular more and more.

Such data communication through a network requires confirmation of the fact that both the sender and the receiver of the data are respectively legal entities authorized for the data transfer, before the required information is actually transferred. In other words, it is a common measure that the data transfer configuration is implemented taking security into account. One of the measures for implementing such a security for data transfer is an encryption processing for the transferred data and/or electronic signature processing.

Encrypted data can resume its usable form, i.e., changed into a plain text or the like, through a predetermined decryption proceeding. Data encryption method and data decryption method have been known, which use an encryption key and decryption key, respectively.

There are a variety of encryption and decryption methods which use encryption and decryption keys. One of such methods, known as a so-called “public key cryptography”, employs different keys for the sender and the receiver, wherein one of the keys is a public key usable by unidentified users, while the other is a secret key which is kept secret. For instance, a data encryption key is used as the public key, while a decryption key is used as the secret key. Alternatively, an authenticator-generating key is used as the secret key, while an authenticator decryption key is used as the public key.

In contrast to a so-called common key cryptography which uses a key commonly for encryption and decryption, the public key cryptography is advantageous with regard to the administration of the keys, because it suffices that only one person has the secret key which has to be kept secret. However, the public key cryptography is used mainly for objects which have small size of data, e.g., delivery of a secret key, digital signature, or the like, because of low data processing speed as compared with the common key cryptography. A typical example of the public key cryptography employs RSA (Rivest-Shamir-Adleman) cryptogram which uses the product of a two large prime numbers each having, for example, 150 digits. This technique relies upon the difficulty in performing prime number factoring of the product of two prime numbers having such large numbers of digits.

The public key cryptography allows unidentified large number of persons to use a public key. In most cases, this technique uses a certificate, i.e., a so-called public key certificate, which certifies that the distributed public keys are legal or authorized keys. For instance, an entity “A” generates a pair of public key and secret key, and sends the generated public key to an authentication authority to obtain a public key certificate from this authority. The entity A opens the public key certificate to public. Unidentified users obtain the public key from the public key certificate through a predetermined procedure, and sends a document to the user A after an encryption. The entity A is a system which, for example, decrypts the encrypted document by using the secret key. This system, i.e., the entity A, attaches a signature to the document by using the secret key, and the signature is verified by unidentified users which have obtained the public key from the public key certificate through a predetermined procedure.

A description will now be given of the public key certificate, with reference to FIG. 1. A public key certificate is a certificate which is issued by an authentication authority such as a certificate authority (CA) or an IA (Issuer Authority). When a user submits its ID, public key and so forth to the authentication authority, the authority adds information such as the ID of the authority, expiry date of the certificate and so on, as well as a signature of the authority, whereby the certificate is generated.

The public key certificate shown in FIG. 1 includes the following pieces of information: a version number of the certificate; a serial number of the certificate, assigned by the authentication authority (IA) to each user of the certificate; the algorithm and parameters used for the electronic signature; name of the authentication authority; expiry date of the certificate; name of the certificate user (user ID); public key of the certificate user; and electronic signature.

The electronic signature is data which is generated by adding a secret key of the authentication authority to a hash value that has bee generated by applying a hash function to the above-mentioned items, i.e., the version number of the certificate, the serial number of the certificate, assigned by the authentication authority (IA) to each user of the certificate, the algorithm and parameters used for the electronic signature, name of the authentication authority, expiry date of the certificate, name of the certificate user (user ID), and the public key of the certificate user.

The authentication authority issues public key certificates of the format shown in FIG. 1, and performs revocation which includes production, administration and distribution of an illegal person list for excluding users who committed illegal deed, as well as update of public key certificates that have been expired. This authority also generates public key and secret key as required.

In order to use the public key certificate, a user verifies the electronic signature of the public key certificate by using the public key of the authentication authority possessed by the user. After the verification has been completed successfully, the user derives a public key from the public key certificate and uses this public key. Therefore, all the users who use the public key certificate have to have a common public key of the authentication authority.

The following problem is encountered with the data transmission system relying upon the public key cryptography using the above-described public key certificate issued by an authentication authority. Namely, if a user wishes to use a different public key, the user has to request the authentication authority to issue a new pubic key certificate for such a different public key or to build a new authentication system which is configured to have the function of an authentication authority. For instance, when a service provider distributing a content or providing a commercial service wishes to use a new public key for a new service which the service provider intends to start, the service provider has to request the authentication authority to issue and administrate a public key certificate for such a new public key or, alternatively, to build up an authentication system that is configured to have a function of an authentication authority. This requires a vast investment of money, as well as time.

Another problem is as follows. When a single user device receives different services offered by a plurality of different service providers, the user had to execute, for each of the different services, a setting of the user device in conformity with the specification or application that had been set by each of the service providers. In addition, the service provider has to conduct various kinds of processing by itself, such as receipt, administration and examination of the user information acquired through user devices, and to execute a processing to determine whether to permit the user to receive the service rendered by the service provider.

For instance, when a user device wishes to start to receive a new service offered by a new service provider, the user has to sent to the service provider the user data and terminal data in accordance with the request given by such a new service provider. The service provider registers the user based on the data given by the user device, and then commences the service.

Thus, user administration and access control have to be done in various ways for different services, which heavily burden both the service provider and the user. In addition, both devices, i.e., the service provider and the user device, are required to store and administrate various kinds of data for registration, thus enhancing the load on each of these devices.

### SUMMARY OF THE INVENTION

Under these circumstances, the present invention is aimed at providing an access control system and an access control method for use in a system in which various service providers provide a variety of types of services, and user devices make accesses such service providers to request to receive such services. The access control system and the access control method proposed by the present invention do not require individual service providers to independently control the accesses made thereto by the user devices.

To this end, according to one aspect of the present invention, there is provided an access control system for use in a data transfer system which transfers data by means of public-key cryptosystem based on a public key certificate issued to an authentication object by a public key issuer authority, the access control system comprising: a service provider which is an authentication object and which provides services; a service receiving device which also is an authentication object and which receives services provided by the service provider; and an access control server which issues to the service receiving device an access permission which identifies a service provider an access to which by the service receiving device is permitted; wherein the service provider performs, based on the access permission, a decision as to whether an access request by the service receiving device is to be permitted.

The access control system may further comprise an access-control-server registration server, wherein the access-control-server registration server is configured to execute a processing for requesting the access control server to execute issuance of the access permission, upon receipt of an access permission issuance request from the service-receiving device.

The access control system may further comprise: at least one system holder which is an organization that provides or controls contents usable by a user terminal, contents which enables provision of services, or a service distribution infrastructure; wherein the system holder is configured to administrate the service provider and the service receiving device and to treat the service provider and the service receiving device as authentication objects.

When a plurality of the system holders are provided, the access control server may be provided for each of the system holders and may be configured to issue the access permission in regard to the services provided by the service provider administrated by the system holder.

The arrangement may be such that a single access control server is provided commonly for a plurality of system holders, and is configured to issue access permissions in regard to the services provided by the service providers administrated by the plurality of system holders.

In one form of the access control system of the present invention, the access control system further comprises a root registration authority which administrates the system holder, wherein the root registration authority is configured to execute, based on a request from the system holder, a processing to request the public key certificate issuer authority to issue the public key certificates of the authentication objects administrated by the root registration authority.

The arrangement may be such that the access control server generates the access permissions in a form independently usable for each of the service providers.

The arrangement also may be such that the access control server generates the access permission in a form commonly usable for a plurality of service providers.

In one form of the access control system of the present invention, the access control server is configured to generate the access permission in a format which comprises: an access-control-server-set fixed field set by the access control server; a service-provider-set option field set by each of the service providers; and an electronic signature field to be performed by the access control server.

The arrangement may be such that the service-provider-set option field includes identification data which indicates for each of the service receiving devices whether an access by the service receiving device is permitted, and wherein the identification data includes at least one of personal information concerning the user of the associated service receiving device, user ID, user device ID, and an access permission discrimination flag.

In one form of the access control system of the present invention, the data transfer between the service provider, the service receiving device and the access control server, performed directly or indirectly through an intermediary, is executed on condition that mutual authentication has been established between the sender of the data and the receiver of the data.

The arrangement also may be such that the data transfer between the service provider, the service receiving device and the access control server, performed directly or indirectly through an intermediary, transfers the data with an electronic signature of the sender added thereto.

In the access control system of the present invention, the service provider may be a device which provides a service.

In the access control system of the present invention, the access control server may be configured to execute an access permission changing processing for revocation of the permission set on the access permission.

In accordance with a second aspect of the present invention, there is provided an access control method for use in a data transfer system which transfers data by means of public-key cryptograph based on a public key certificate issued to an authentication object by a public key issuer authority, the access control method comprising the steps of: receiving, at a service provider, an access permission from a service receiving device, the access permission having been issued by a service control server; and executing, based on the access permission, a determination as to whether access requested by the service receiving device is to be permitted.

The access control method may further comprise: an access permission issuing step for issuing, at an access control server, an access permission which is delivered to the service receiving device and which enables identification of the service provide an access to which is permitted by the service receiving device.

The access control method may further comprise the steps of: receiving, at an access-control-server registration server, the access permission issuance request from the service receiving device and requesting, at the access-control-server registration server, the access control server to execute the processing for issuing an access permission.

The access control method of the present invention may be such that the access permission issuing step is executed based on an issuance request from a service provider which is under the administration of a system holder as an organization that provides or controls contents usable by a user terminal, contents which enables provision of services, or a service distribution infrastructure.

The access permission issuing step generates the access permissions in a form independently usable for each of the service providers.

The access control method of the present invention may be such that the access control server generates the access permission in a form which is commonly usable for a plurality of service providers.

The access control method of the present invention also may be such that the access permission issuing step generates the access permission of a format which comprises: an access-control-server-set fixed field set by the access control server; a service-provider-set option field set by each of the service providers; and an electronic signature field to be performed by the access control server.

The access control method of the present invention may be such that the step executed by the service provider for determining whether the access is to be permitted is executed based on identification data which determines whether the access is to be permitted for each of the service receiving devices and which is contained in the access permission, the identification data including at least one of personal information concerning the user of the associated service receiving device, user ID, user device ID, and an access permission discrimination flag.

The access control method of the present invention may be such that the data transfer between the service provider, the service receiving device and the access control server, executed directly or indirectly through an intermediary, is executed on condition that mutual authentication has been established between the sender of the data and the receiver of the data.

The access control method of the present invention may be such that the data transfer between the service provider, the service receiving device and the access control server, executed directly or indirectly through an intermediary, transfers the data with an electronic signature of the sender added thereto.

The access control method of the present invention may further comprise an access permission changing processing executed by the access control server to revoke the permission set on the access permission.

In accordance with a third aspect of the present invention, there is provided a device having a data processing function, comprising: communication processing means for executing data transfer processing; cryptographic processing means for executing cryptographic processing on data; and data storage means; wherein the data storage means stores an access permission containing service provider identification data which identifies the service provider an access to which by a device ha been permitted; the cryptographic processing means executes an electronic signature on the access permission; and a processing for sending the access permission with the electronic signature is executed via the communication processing means.

In the device of the present invention, the access permission may be a permission which is issued by an access control server that executes administration of control of access by the device to the service provider, and the device may be configured to execute, by the cryptographic processing means, a processing for verifying the signature made by the access control server and added to aid access permission.

The device of the present invention may be configured to store in the data storage means one or more access permissions each containing service provider identification data for a single service provider, or an access permission containing service provider identification data for a plurality of service providers, and to send, through the communication processing means, an access permission selected based on the access destination.

The device of the present invention may be configured to execute mutual authentication between the device and the service provider to which the access permission is directed and to execute, on condition of the establishment of the authentication, a processing for encrypting the access permission with the electronic signature executed thereon and sending the encrypted access permission to the service provider.

In accordance with the fourth aspect of the present invention, there is provided an access control server which executes a processing for issuing an access permission which indicates that a device is permitted to access a service provider, the access control server comprising: communication processing means for executing data transfer processing; and cryptographic processing means for executing cryptographic processing of data; wherein the access control server is configured to execute: a processing for receiving, through a service provider, an access permission issuance request given by a device which requests an access to the service provider; and a processing for issuing an access permission which contains, at least, data concerning whether the device is permitted to access the service provider and an electronic signature executed by the access control server.

The access control server of the present invention may be configured to execute a processing for verifying the electronic signature of the sender added to the access permission issuance request, and to execute the processing for issuing the access permission on condition that the verification of the electronic signature has been successfully achieved.

The access control server of the present invention also may be configured to execute a processing for mutual authentication between the access control server and the entity which is the sender of the access permission issuance request, and to execute a processing for receiving the access permission issuance request on condition that the mutual authentication has been established.

The access control server also may be configured to execute, when executing the processing for issuing the access permission, a processing for mutual authentication between the access control server and the entity which is the sender of the access permission issuance request, and to execute a processing for encrypting the access permission and sending the encrypted access permission to the entity, on condition that the mutual authentication has been established.

The access control server also may be configured to execute a processing for generating and issuing an access permission containing service provider identification data for a single service provider, or an access permission containing service provider identification data for a plurality of service providers.

In accordance with a fifth aspect of the present invention, there is provided an access-control-server registration server which executes a processing for sending a request to an access control server requesting issuance of an access permission, the access control server being responsible for executing a processing for issuing an access permission indicating that a device is permitted to access a service provider, comprising: communication processing means for executing data transfer processing; and cryptographic processing means for executing cryptographic processing of data; wherein the access-control-server registration server receives, through a service provider, an access permission issuance request given by a device which requests an access to the service provider; and wherein the access-control-server registration server further executes, upon receipt of the access permission issuance request, a processing for executing an electronic signature and then executes a processing for requesting the access control server to issue the access permission.

The access-control-server registration server in accordance with the present invention may be configured to execute: a processing for receiving the access permission issued by the access control server; a processing for verifying the signature of the access control server that has been added to the received access permission; and a processing for sending the received access permission to the service provider, after adding a signature of the access-control-server registration server to the access permission.

The access-control-server registration server of the present invention also may be configured to execute: a mutual authentication processing between the access-control-server registration server and an entity which is the sender of the access permission issuance request, and a processing for receiving the access permission issuance request on condition that the authentication has been achieved.

In accordance with a sixth aspect of the present invention, there is provided a data processing apparatus serving as a service provider which accepts accesses from a plurality of devices and which provides services in response to the accesses, the data processing apparatus comprising: communication processing means for executing a data transfer processing; and cryptographic processing means for executing a cryptographic processing on data; wherein the data processing apparatus is configured to execute: a processing for receiving, from the device, an access permission accommodating a service provider identification data that identifies the service provider to which the device has been permitted to make an access; and a processing for determining, based on the data contained in the received access permission, whether the device is to be permitted to make an access.

In the data processing apparatus in accordance with the present invention, the access permission may be a permission which has been issued by the access control server in response to the access permission issuance request sent from the service provider and to which an electronic signature has been added by the access control server; and wherein the data processing apparatus serving as the service provider is configured to execute a processing for verifying the electronic signature on the access permission received from the device, and a processing for permitting the device to make the access, upon confirming, through the verification, that the access permission is a true permission issued by the access control server.

The data processing apparatus serving as the service provider may be configured to execute: a mutual authentication processing between the data processing apparatus and the device, and a processing for receiving the access permission issuance request.

The data processing apparatus serving as the service provider may be configured to execute: a mutual authentication processing between the data processing apparatus and the device, and a processing for sending, on condition of establishment of the authentication, the access permission, after addition of a signature of the service provider and an encryption of the access permission.

In accordance with a seventh aspect of the present invention, there is provided a program storage medium which provides a computer program that runs on a computer system to implement an access control processing in a data transfer system which transfers data by means of public-key cryptograph based on a public key certificate issued to an authentication object by a public key issuer authority, the computer program comprising the steps of: receiving, at a service provider, an access permission from a service receiving device, the access permission having been issued by a service control server; and executing, based on the access permission, a determination as to whether access requested by the service receiving device is to be permitted.

The program storage medium of the present invention is a medium which provides, in a computer-readable form, a computer program to, for example, a general-purpose computer system which can run various program codes thereon. The medium can have a variety of forms such as a CD, FD or an MO and also may be a transmission medium such as a network. Thus, there is no restriction in the form of the medium.

The program storage medium defines a structural or functional cooperative relationship between a computer program and the storage medium, necessary for implementing the function of the computer program on a computer system. In other words, a computer program can be installed on a computer system through the storage medium, so that the cooperative operation is performed on the computer system, whereby the same advantages as those offered by other aspects of the invention can be achieved.

These and other objects, features and advantages of the present invention will become clear from the following description of the embodiments taken in conjunction with the accompanying drawings.

### BRIEF DESCRIPTION OF THE DRAWINGS

FIG. 1 is an illustration of an example of a public key certificate;

FIG. 2 is a diagram schematically showing a data communication system which uses a public key cryptography in accordance with the present invention;

FIG. 3 is an illustration of the relationship between a system holder and other entities in the data communication system using the public key cryptography;

FIG. 4 is a chart showing other examples of the relationship between the system holder and other entities in the data communication system using the public key cryptography;

FIG. 5 is an illustration of an example of the use of a public key certificate when a system holder does not have hierarchical structural relationship to a root registration authority;

FIG. 6 is an illustration of an example of the use of a public key certificate when a system holder has a hierarchical structural relationship to a root registration authority;

FIG. 7 is a schematic illustration of Example 1 of a system which includes an access control server as a component thereof;

FIG. 8 is a schematic illustration of Example 2 of a system which includes an access control server as a component thereof;

FIG. 9 is an illustration of an example of the access permission;

FIG. 10 is an illustration of a format of the access permission;

FIG. 11 is a presentation of the content of the access permission;

FIG. 12 is an illustration of a processing for generating an electronic signature adaptable to a system in accordance with the present invention;

FIG. 13 is an illustration of a signature verification processing adaptable to the system of the present invention;

FIG. 14 is an illustration of part of a mutual authentication processing adaptable to the system of the present invention;

FIG. 15 is an illustration of another part of the mutual authentication processing adaptable to the system of the present invention;

FIG. 16 is a table showing the definition of terms used in the processing performed by the system of the present invention;

FIG. 17 is a diagram showing a processing sequence for issuing the first access permission;

FIG. 18 is a diagram showing a processing sequence for issuing an access permission;

FIG. 19 is a diagram showing a sequence of a service ceasing processing on an access permission performed in the access control system of the present invention;

FIG. 20 is a diagram showing a sequence of a service invalidation processing on an access permission performed in the access control system of the present invention;

FIG. 21 is an illustration of a service invalidation processing sequence performed mainly by a system holder of an access permission in the access control system of the present invention;

FIG. 22 is an illustration of a sequence for the use of access permission in the communication between devices in the access control system of the present invention;

FIG. 23 is an illustration of an example of configuration of a device incorporated in the access control system of the present invention; and

FIG. 24 is an illustration of an example of the configuration of the access control system in accordance with the present invention, including an access control server, an access-control-server registration server, and a data processing apparatus serving as a service provider.

### DESCRIPTION OF THE PREFERRED EMBODIMENTS

Preferred embodiments of the present invention will be described in detail with reference to the accompanying drawings.

[Outline of Data Distribution System Having Hierarchical Configuration]

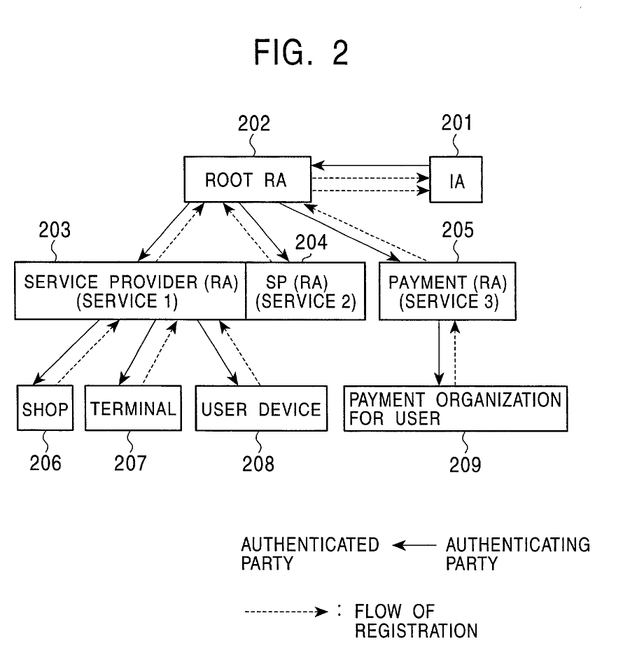

A description will be first given of an example of the system configuration of a data communication system which can implement the access control system and the access control method and which uses a public key cryptography, with specific reference to FIG. 2.

Referring to FIG. 2, a shop 206, a terminal 207, a user device 208 and a payment organization 209 for user are the objects of authentication, i.e., the subjects or entities that execute data transmission and receipt under the public key cryptography. Although only one entity is shown for each type of the authentication objects, it will e understood that in general there are many entities for each type of the authentication objects, and other types of authentication objects also may be involved.

Hereinafter, a term “RA” is sometimes used as an abridgement of registration authority. The shop 206, terminal 207 and the user device 208 are under administration of registration authorities 203, 204 (service provider RAs), and the payment organization 209 is under administration of a registration authority (payment RA) 205. These entities send requests to the administrating RAs to issue public key certificates corresponding to the public keys used by them.

The registration authorities 203 and 204 serve to authenticate the subjects which receive services, i.e., entities or devices which take part in the services, while the registration authority 205 authenticates the entity responsible for the payment to be done on behalf of the entity that receives the service. The registration authorities 203, 204 and 205 receive the public key certificate issuance requests given by the objects of the services, i.e., the entity participating in the service, device and the user, for the public keys used by these objects, and transfers these requests to a public key issuer authority (IA) 201 via a root registration authority (root RA). The root registration authority (root RA) 202 receive the public key certificate issuance requests sent from the authenticated registration authorities 203, 204 and 205. More specifically, the root registration authority receives the public key certificate issuance requests only from registration authorities that have been authenticated by the root registration authority (root RA) 200.

Referring to FIG. 2, registration authorities (service provider RAs) 203 and 204 are service providers that execute distribution services such as distributions of music data, image data and game programs, while the registration authority (payment RA) 205 is a clearing center which sends and receives data to and from a user's payment organization 209 such as a bank for the purpose of clearance by means of electronic money held by the user. The RAs are shown in FIG. 2 only by way of examples, and various other RAs that provider a wide variety of services may be employed.

Different RAs exist for different services or systems. The aforementioned root registration authority (root RA) 202 is a general RA which perform overall authentication of these RAs. The root RA itself is authenticated by an IA (issuer authority) which will be described later. The registration authorities 203, 204 and 205 are small-scale service entities and may be substituted by the root RA 202 when the service provider does not have its own RA.

The IA 201 performs mutual authentication between itself and the root RA 202 or between itself and the RAs 203 to 205. The IA then forms a public key certificate based on the object identifier (ID) identifying the object which is the subject of the public key certificate issuance request received from the RAs 203 to 205, as well as other kinds of information to be written in the certificate, and distributes the public key certificate to the RAs 203 to 205.

The root RA 102 or the RAs 103 to 205 can request the IA 201 only when they have been authenticated by the IA 201.

Upon receipt of a request from the root RA 202 or one of the RAs 203 to 205, the IA 201 performs various kinds of processing such as updating, invalidation and deletion of the public key certificate, as well as responding processing in repose to validity confirmation request given from an object. The IA 201 subjects to authorization under an appropriate law or regulation, and, with such authorization, the IA 201 is deemed as having been authenticated.

[Data Distribution Configuration Having a System Holder as Component]

A description will now be given of a configuration having the described hierarchical structure composed of the root registration authority (root RA) and the registration authorities (RA), wherein each registration authority (RA) is configured as a system holder (SH).

A system holder (SH) is an entity such as an organization that organizes and administrates, for example, an internet shop market which is implemented on the internet, an organization that provides infrastructure for mobile phones, an organization that administrates the use of cables of a cable television system, or an entity that issues electronic money or cards. Thus, the system holder is defined as an organization that provides and administrates an infrastructure for enabling various kinds of contents and services.

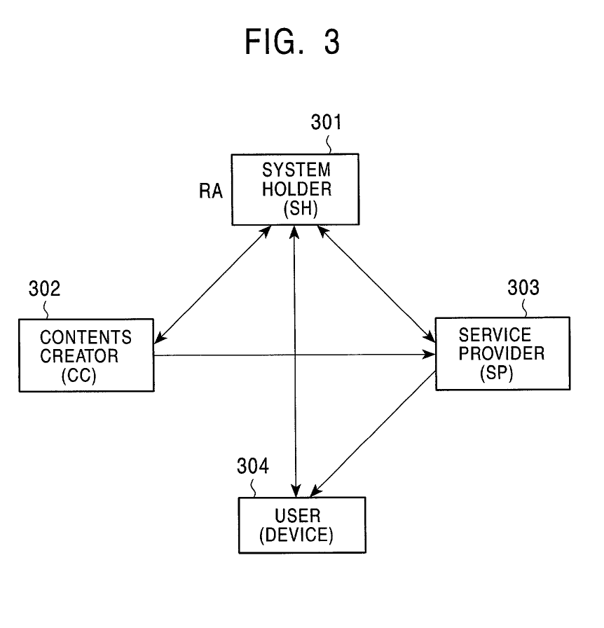

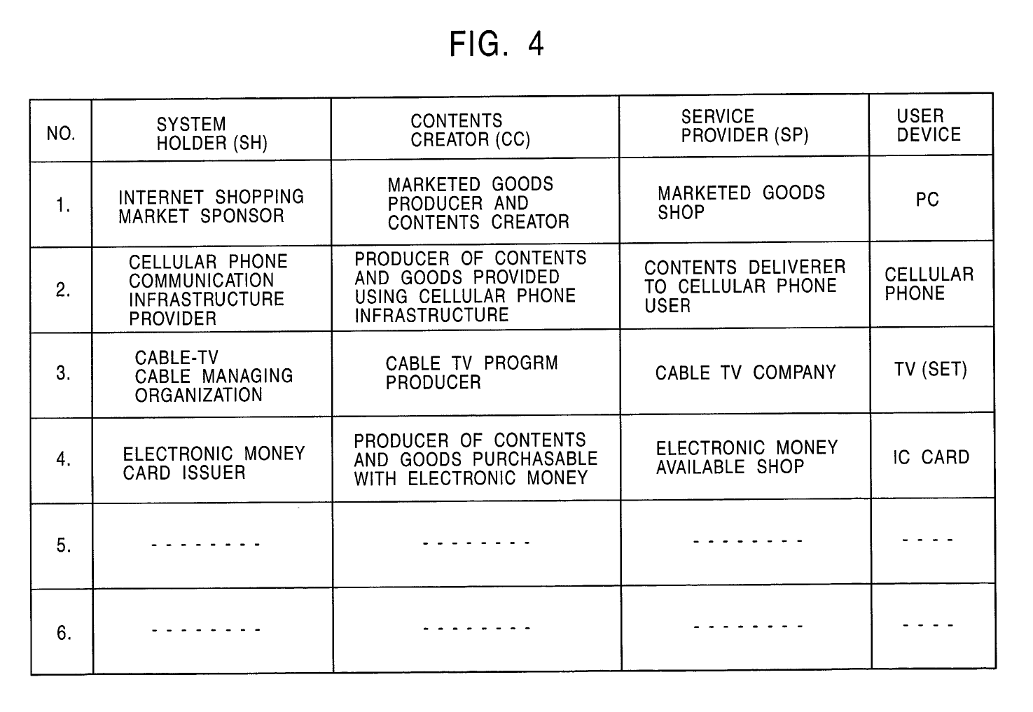

FIG. 3 shows a relationship between the system holder 301, content creator 302, service provider 303 and a user 304. FIG. 4 shows practical examples of the system holder, content creator, service provider, and a user device.

Referring to FIG. 3, the system holder 301 provides a distribution infrastructure for enabling distribution of contents or services which can be used on the content creator 302, service provider 303 and the user (device) 304. The content creator 302 and the service provider 303 are operative to provide contents or services by using the infrastructure provided by the system holder 301. The user (device) 304 receives the service rendered by the service provider 303, by using the infrastructure provided by the system holder 301.

FIG. 4 shows practical examples of the system holder, content creator, service provider and the user device. As will be seen from FIG. 4, assuming that the system holder (SH) is an organization that opens and administrates an internet shop market, the content creator (CC) provides commercial goods which are merchandized on the internet shop market. The service provider (SP) is a shop which sells on the internet shop market the commercial goods provided by the content creator (CC). The user device is, for example, a PC which is a customer of the internet shop.

Alternatively, when the system holder (SH) is an organization which provides an infrastructure for mobile phones, e.g., a telecommunication company, the content creator (CC) forms or produces a content or commercial goods that can be provided through the mobile telephone communication infrastructure. The service provider (SP) sells and provides, through the mobile phone communication infrastructure, the content or commercial goods provided by the content creator (CC). In this case, a mobile telephone set serves as the user device.

If the system holder (SH) is an organization that provides a cable television communication infrastructure, e.g., a company that administrates cables of a cable television system, the content creator (CC) creates contents or commercial goods that can be provided through the cable television communication infrastructure. The contents may be broadcast programs provided to cable television. The service provider (SP) sells or provides to the user the contents or commercial goods provided by the content creator (CC), through the cable television communication infrastructure. For instance, the system holder (SH) in this case is a cable television company which directly charges the viewers and listeners.

If the system holder (SH) is an organization that provides an electronic money clearing infrastructure, e.g., an organization that issues electronic money, the content creator (CC) is an organization which provides contents or commercial goods which are available, i.e., purchasable, through clearance by electronic money, while the service provider (SP) is a shop which sells the contents or goods provided by the content creator (CC) through electronic money clearance. In this case, the user device is, for example, an IC card which can deposit electronic money.

Various other kinds of system holder (SH) are usable. The content creator (CC), service provider (SP) and the user device are configured in accordance with the kind of the system holder. Thus, the system holder (SH) is defined as being an organization that provides and administrates an infrastructure for distribution of contents or services for enabling provision of the contents and services that can be dealt with and used by the content creator (CC), service provider (SP) and the user device.

A description will now be given of a configuration which distribution of contents or services and which can easily be used by users, wherein the system holder (SH) plays the role of the aforementioned registration authority (RA).

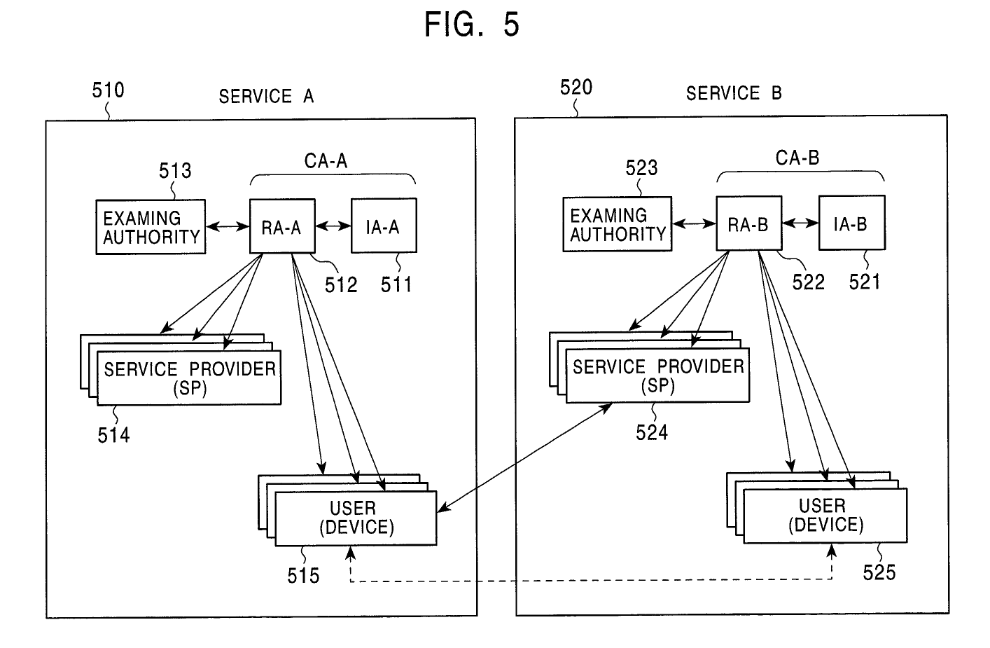

Referring first to FIG. 5, there is shown a configuration for distribution of contents or services relying on a public key cryptography, wherein the function of the registration agent (RA) is not assigned to the system holder (SH).

As will be seen from FIG. 5, a variety of services are available for use by users. Each service is provided under its own public key cryptography, i.e., its own examination and registration, with issuance of a public key certificate which is effective only for each specific service. Thus, FIG. 5 shows a conventional configuration of a system which provide a variety of services. More specifically, in the system shown in FIG. 5, there are two groups providing services: namely, a group 510 which provides a service “A” and a group 520 which provides a service “B”.

The group 510 which provides the service “A” includes a public key issuer authority (IA-1) 511 usable for the provision of the service “B”, service providers (SP) 514 which request to use public key certificates, and a registration authority (RA-A) 512 which conducts registration and administration of user devices 515. The registration authority 512 registers the service providers 514 and the users (devices) 515 based on an examination conducted by, for example, a public examination organization 513. The registration authority 512 also requests the public key certificate issuer authority (IA-A) 511 to issue a certificate to conduct administration of the service providers 514 and the users (devices) 515. The public key certificate issuer authority (IA-A) 511 and the register authority 512 in combination provide an authentication authority (CA-A).

The group 520 includes, in order to provide the service “B”, public key certificate issuer authority (IA-B) 521 usable for the provision of the service “B”, service providers (SP) 524 which request to use public key certificates, and a “RA (RA-B) 522 which conducts registration and administration of users (devices) 525. The registration authority 522 conducts registration of the service providers 524 and the users (devices) 525 based on an examination executed by, for example, a public examination authority 523. The registration authority 522 also requests the public key certificate issuer authority (IA-B) to issue certificates to administrate the service providers 514 and the users 8 devices) 525. The public key certificate issuer authority (IA-B) 521 and the registration authority 522 in combination provide an authentication authority B (CA-B).

A problem or difficulty is encountered when one of the users 515 who has been registered through the registration authority (RA-A) to use the service “A” and who has received a public key certificate usable for the service “A”, wishes to use also the service “B”. The public key certificate which the user 512 already has cannot be used for the service “B”. In order to enjoy the service “B”, the user 512 is required to apply for a registration through the registration authority (RA-B) which administrates the service “B” to obtain a new public key certificate usable for the service “B”.

This problem or difficulty would be overcome if the authentication authorities (CAs), each being composed of a public key certificate issuer authority and an registration authority, are arranged to execute mutual authentication or arranged to form a hierarchical configuration. Such solutions, however, inevitably leads to an increase in the processing load on the authentication authorities (CAs) and requires intricate configurations of the same. Another problem is that, if the user stores in its device a plurality of public key certificates for receiving a plurality of services, a large part of the storage area in the user device is undesirably occupied by such public key certificates. This problem is noticeable particularly when the user device has only a small memory area, as is the case of an IC card.

A still another problem occurs when a demand exists for mutual authentication to be done in, for example, off-line manner, between the user device 515 and the user device 525 in the configuration shown in FIG. 5. Such a mutual authentication is impossible because thee user devices 515 and 525 are under the control of different authentication authorities (CA). In order that such a mutual authentication is successfully executed, each of the user devices has to store therein both of the public key authenticated by the authentication authority managing the user device and the public key authenticated by the authentication authority which administrates the other user device. When a user device requires authentication between itself and a variety of types of other user devices, the number of the public keys to be stored is further increased.

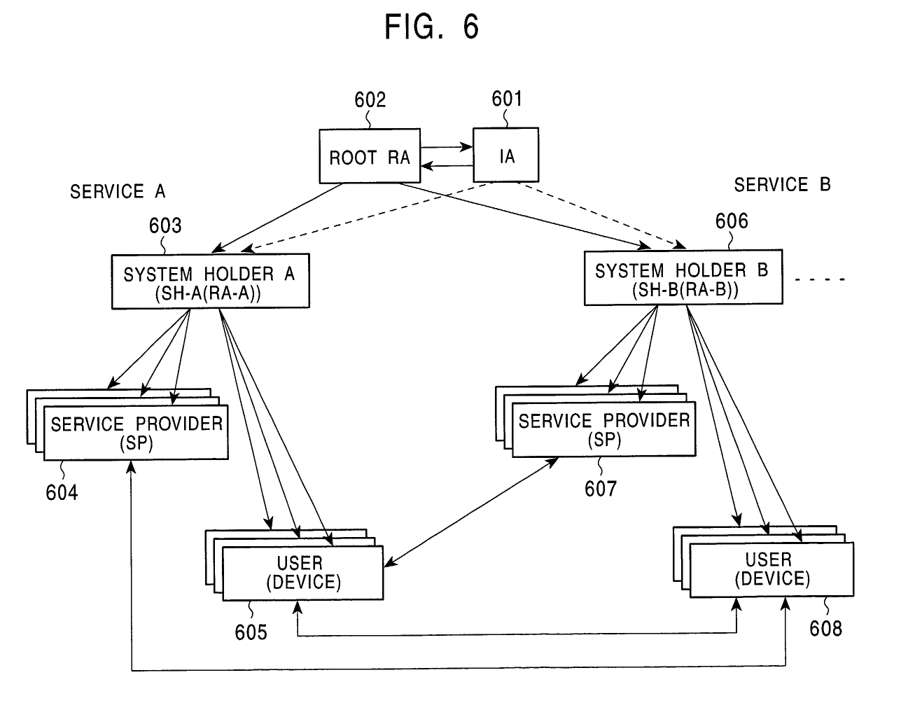

Thus, the conventional configuration shown in FIG. 5, which conducts independent administration for individual services, is encountered by various problems. A hierarchical configuration shown in FIG. 6, in which a system holder (SH) underlies the root registration authority (root RA), solves the above-described problems.

A description will now be given of the configuration shown in FIG. 6. As in the case of the configuration shown in FIG. 5, a service provider group which pertain to a service “A” is shown at the left-hand side of the figure, while the service provider group for a service “B” is shown at the right-hand side of the figure. Thus, service providers 604 are the subjects or entities which offer the service “A”, while service providers 607 are the subjects or entities that offer the service “B”.

In this configuration, the service providers 604, users (devices) 605, service providers 607 and the users (devices) 608 are the objects of authentication, i.e., the entities which conduct data transmission under the public key cryptographic system. Although only two types of service “A” and “B”, it will be apparent that the configuration can generally involve a large number of different kinds of services.

In this configuration, the system holder A 603 has the same role and function as those of the registration authority in the configuration shown in FIG. 5. Thus, each of the authentication objects, i.e., each of the service providers 604 and each of the users devices) 605 under the management of the system holder A 603 request the system holder A 603 to issue a public key certificate corresponding to the public key which is used by such a service provider or user. Likewise, the system holder B 606 receives, from each of the authentication objects under its management, i.e., each of the service providers 607 and each of the users (devices) 608, a request for issuance of a public key certificate.

Each of the system holder A 603 and the system holder B 606 authenticates the objects in each service, i.e., each of the entities and devices which take part in the service. Each of the system holder A 603 and the system holder B 606 also serves to receive public key certificate issuance requests for the public keys used by the objects of each service, i.e., entities, devices and users involved in the service, and transfers the received requests to the public key certificate issuer authority (IA) 601 directly or indirectly via the root registration authority (root RA) 602.

When the request is sent to the public key certificate issuer authority 601 via the root registration authority (root RA) 602, the root registration authority 602 receives the public key certificate issuance request from the system holder A 603 or the system holder B 606 on which an authentication has been successfully achieved. In other words, the public key certificate issuance request received by the root registration authority (root RA) 602 is a request from the system holder A 603 or the system holder B 606 which has been authenticated by the root registration authority (root RA) 602 itself. Successful establishment of authentication is an essential condition also when data communication is conducted directly between public key certificate issuer authority (IA) 601 and the system holder A 603 or the system holder B 606.

Referring further to FIG. 6, each of the service providers 604 and 607 is a service provider which conducts distribution service for distributing contents such as music data, image data, game program, or the like, and is implemented by any of the service providing subject or entity described before in connection with FIG. 4.

The system holder A 603 and the system holder B 606 are organizations which administrate infrastructures for the services provided by the service providers 604 and 607. As explained before with reference to FIG. 4, these system holders may e implemented by, for example, a provider of a mobile phone communication infrastructure, an organization which issues electronic money or cards, or the like.

An advantageous feature of this configuration resides in that the system holder, which is inherently an organization that provides or administrates an infrastructure for implementing provision of contents or services, also conducts additional jobs such as authentication based on public key certificates, mediation of the procedure for issuance of public key certificates requested by the service providers and user devices which execute data communication, and registration and administration of such service provides and user devices. The system holder, which is inherently an organization that provides or administrates an infrastructure for implementing provision of contents or services, is normally configured to administrate the users or service providers that use such an infrastructure and, therefore, is equipped with a database for such administration. In this embodiment, the administration database is used also for administration of the objects to which the public key certificates are to be issued, thus achieving high efficiency of the work for administrating the users or service providers.

The described configuration offers advantage also when a new system holder has been put to use due to, for example, building up of a new communication infrastructure. In such a case, the new system holder is placed under administration of the existing root registration authority (root RA) and existing public key certificate issuer authority (IA), so that a configuration for issuance of public key certificate using the new infrastructure can easily be implemented, whereby services using such a new infrastructure become available without delay.

It is also to be noted that each user device can enjoy various services, with only one public key certificate stored therein. More specifically, in the configuration shown in FIG. 6, only one root registration authority (root RA) and only one public key certificate issuer authority (IA) are used for a variety of system holders and service providers, so that the user device can receive different services by using only one public key certificate. Further, mutual authentication between user devices which are under administration of different system holders is possible, because these devices use public key certificates which have been issued from the single common public key certificate issuer authority.

[Data Distribution Configuration Using Access Control Server as Component]

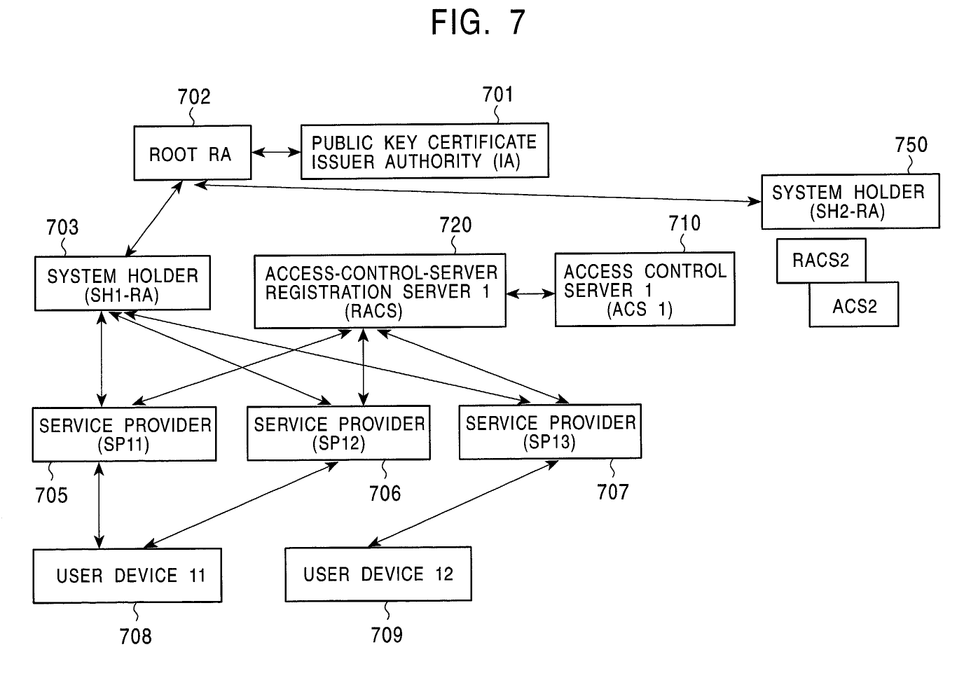

A description will now be given of a configuration in which the above-described architecture employing system holders further employs access control serves as its components. FIG. 7 is a block diagram showing the configuration of a data distribution system which employs an access control server and which uses public key certificates.

Referring to FIG. 7, the data distribution system includes the following components: a public key certificate issuer authority (IA) 701 which issues public key certificate; a root registration authority 702 which administrates one or more system holders; system holders 703 and 750 which administrate one or more service providers and one or more devices; service providers 705, 706 and 707 which provide various serves such as distribution of contents to the user devices; and the user devices 708 and 709 which receive the services provided by the above-mentioned service providers. The system further includes an access control server 710 and an access-control-server registration server 720. In this configuration, the service providers and the user devices are the main entities that transmit and receive data, i.e., the subjects which execute data transmission and receipt based on the public key cryptography.

The access control server 710 is set to serve for one system holder 703, and executes a processing for issuing public key certificates for the devices 708 and 709 to determine whether these devices 708 and 709 are to be permitted to make access to the service providers 705 to 707 which are under the administration of the system holder 703. Namely, the access control server 710 issues to the user devices 708 and 709 access permissions specifying the service providers to which these user devices 708 and 709 are permitted to access. When making access to such service providers 705 to 707, the user devices 708 and 709 show to the service providers 705 to 707 the access permissions that have been issued by the access control server 710. Each service provider determines whether to accept the access, based on the access permission received from the user device 708 or 709. The detail of the access permission will be described later.

The access-control-server registration server 720 communicate with the service providers 705 to 707 which are under administration of the system holder 703. The access-control-server registration server 720 receive access permission issuance requests from the user devices 708 and 709 via the service providers 705 to 707, and request the access control server 710 to issue the access permissions based on the access permission issuance request received from the user devices 708 to 709.

Each of the entities, i.e., the root RA, SH, SP and the user devices, of the configuration shown in FIG. 7 has its public key certificate issued by the public key certificate issuer authority. Data communication between these entities is executed on condition that authentication based on the public keys has been successfully achieved, with an encryption, if necessary, y generating and using a session key.

The arrangement shown in FIG. 7 employs the access control server 710 and the access-control-server registration server 720 which are used for only one system holder 703. Obviously, however, the arrangement may be such that the access control server and the access-control-server registration server are used commonly for a plurality of system holders.

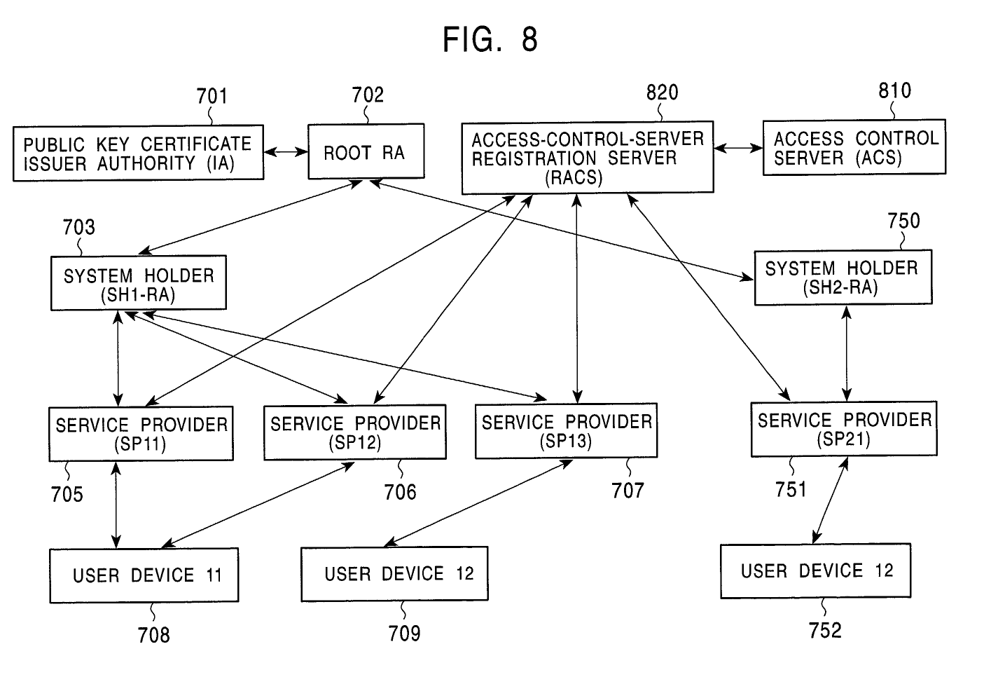

FIG. 8 shows a configuration in which an access control server and an access-control-server registration server are used commonly for a plurality of system holders. Referring to FIG. 8, an access control server 810 and an access-control-server registration server 820 are arranged so as to serve commonly for a plurality of system holders 703 and 750. Service providers 705 to 707 and user devices 708 and 709 which are all under administration of the system holder 703, as well as the service provider 751 and user device 752 which are under administration of the system holder 750, are administrated by the access control server 810 and the access-control-server registration server 820, and use access permissions issued by the access control server 810.

[Access Permission]

A description will now be given of the access permission issued by the access control server shown in FIGS. 7 and 8. There are shown two forms of issuance of the access permissions. In the first form of issuance, an access permission peculiar to one service provider and effective only for the communication with such service provider is issued. This form will be referred to as “form A”. The second form of issuance is to issue an access permission which is effective commonly for a plurality of service providers. This form will be referred to as “form B”.

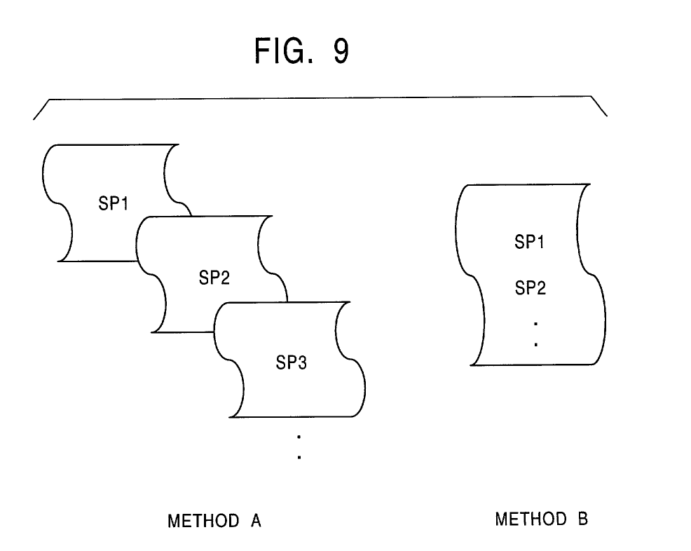

These two forms of issuance are illustrated in FIG. 9. In accordance with the issuance form A, the access permission is prepared for each of the service providers requiring to fill in the item blanks requested by the service provider. The access permission prepared in accordance with this form is effective with regard to only one service provider. In contrast, the issuance form B, which is usable commonly with regard to a plurality of service providers, is prepared so as to contain data items requested by these service providers. When the access permission is issued in the form “A”, the user device has to have a plurality of access permissions to be enabled to make access to a plurality of service providers. In contrast, the user device can make access to a plurality of service provides, by using only one common access permission, if the user device has the access permission issued in the form “B”.

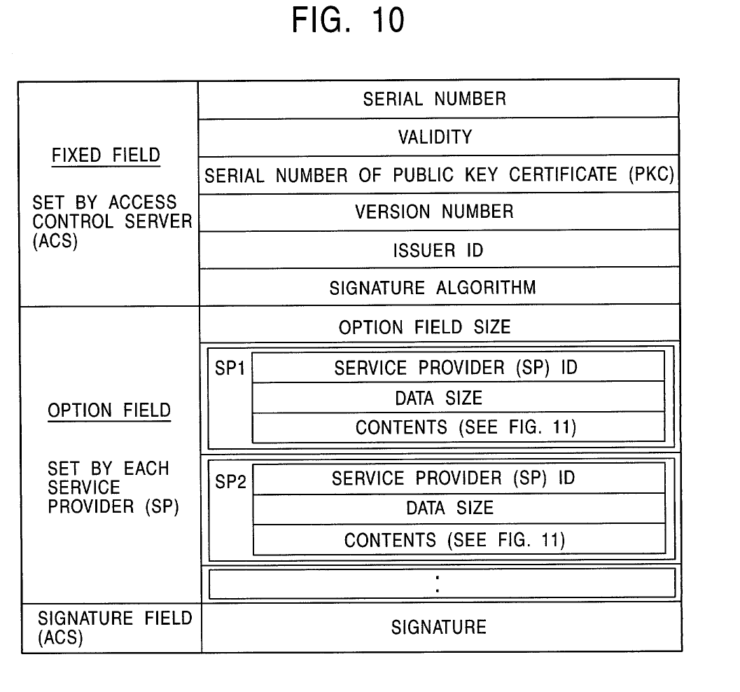

FIG. 10 shows a sample of the access permission prepared in the form “B”. The access permission has a plurality of fields: a fixed field to be set by the access control server (ACS), an option field to be set by each service provider (SP) and a signature field to be filled by the access control server (ACS).

The fixed field has the following items: the serial number of the access permission; validity of the access permission; serial number of the public key certificate (PKC) of the object to which the access permission is to be issued; version number of the format of the access permission; identification name of the issuer of the access permission, which is the access control server in this case; and the signature method which identifies the algorithm, e.g., an elliptic curve encryption method or RSA method, of the signature added to the access permission.

The serial number is the serial number of the access permission set by the access permission issuer which in this case is the access control server (ACS).

The item “validity” indicates the date and time at which the certificate comes into effect and the data and time at which the period of validity terminates.

The serial number of the public key certificate (PKC) shows the serial number of the public key certificate possessed by the user device which uses the access permission.

The issuer ID field is a field which shows the name of the issuer of the access permission, i.e., the distinguished name, which is the access control server (ACS) in this case, recorded in a distinguishable form.

The signature method field is a field which shows the signature algorithm and its parameters for the signature added to the access permission. For instance, the signature algorithm may be an elliptic curve cryptographic algorithm or RSA algorithm. In the former case, this field also shows the parameters and the key length, whereas, when the latter is used, the key length is recorded.

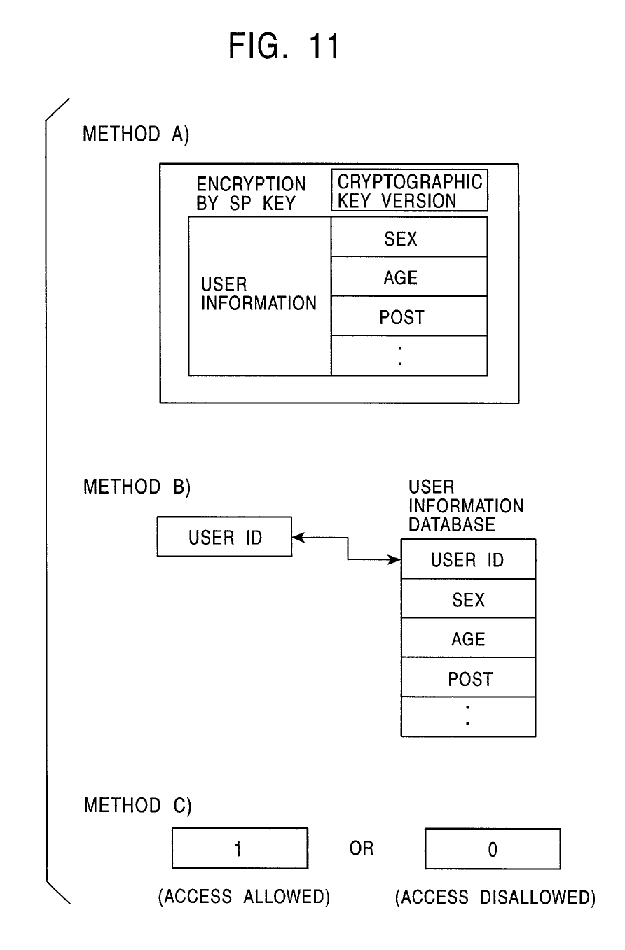

The option field is a field which is to be filled in by individual service providers (SP). Thus, the option field is composed of sub-fields allocated to a plurality of service providers, each sub-field containing the distinguished name of the service provider, data size and contents. Practical example of the contents will be described later with reference to FIG. 11. The data size of the whole option field is also recorded.

The signature field is used for a signature of the issuer of the access permission which in this case s the access control server (ACS).

FIG. 11 shows a practical example of the field used for the “contents” which is defined in the option field and which is to be set by the service provider.

Referring to FIG. 11, a method “A” shows an example in which user information is stored as the “contents”. The user information may include, for example, the sexes, ages, positions and so forth of the users. In most cases, the user information includes private information and, therefore, is stored after an encryption with a secret key own to the service provider. In such a case, an encryption key version is also recorded, so that the service provider executes decryption of the user information by using its secret key as necessary.

The method “B” shown in FIG. 11 shows an example in which user IDs alone are stored as the “contents”. The service provider can set up a link to its own user information database, based on the user ID, so that the service provider can acquire necessary user information. In accordance with this method, the user information is directly administrated by means of the database possessed by the service provider, thus avoiding duplication of the user information which occurs when the user information is written also in the access permission. This method therefore offers a high level of security, by diminishing the risk of leakage of personal information.

In the method “C” sown in FIG. 11, only information indicating whether the user is permitted (allowed) to make an access is written as the “contents”. For instance, the service provider sets this field to “1” when it permits the user to make access and “0” when it does not permit. This method is particularly useful for a configuration in which whether to permit access is determined solely base on whether the user has been registered, without considering personal information of the user. This method effectively reduces the size of the data contained in the access permission, because the size of the data contained in this field is very small.

A further reduction in the data size is possible when the bits of the “contents” field for permission or rejection are allocated to a plurality of service providers, such as SP1: 0, SP2: 1, . . . , SPn, 0.

[Electronic Signature Processing and Authentication Processing]

A description will now be given of the processing for issuing an access permission, as well as the use of the access permission, in the access control system of the present invention. More specifically, description will be given of the electronic signature generating processing, verification processing, and authentication processing which are executed by each entity. After a description of the electronic signature generation processing and the mutual authentication processing, a detailed description will be given of a practical example of the use of the access permission proposed by the present invention.

[Electronic Signature]

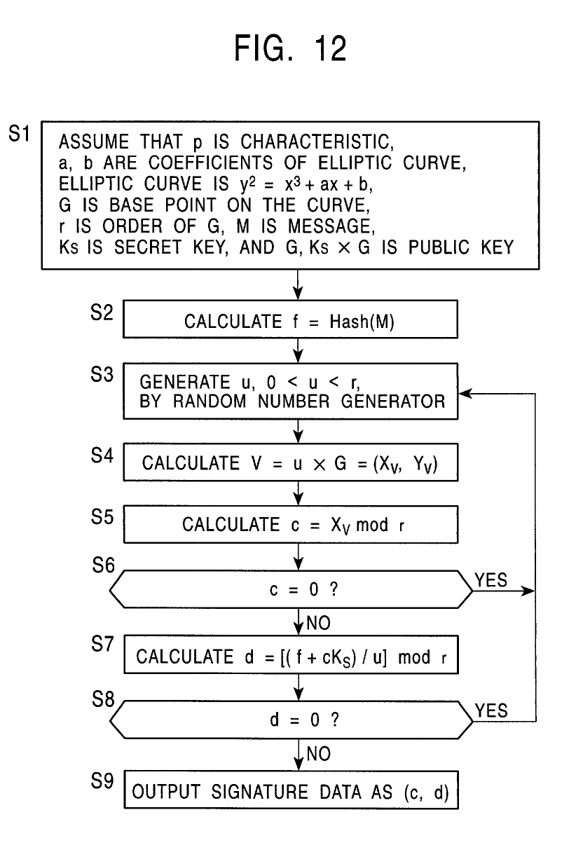

A method of generating an electronic signature under a public key cryptography will be described with specific reference to FIG. 12. FIG. 12 shows a flow of an electronic signature data generating processing which uses EC-DSA (Elliptic Curve Digital Signature Algorithm: IEEE P 1363/D3). Although not exclusive, the technique shown in FIG. 12 employs elliptic curve cryptography (referred to as “ECC”, hereinafter). It is to be noted that the data processing apparatus of the present invention may use other types of cryptography than the illustrated elliptic cure cryptograph, such as RSA cryptograph (Rivest, Shamir, Aldeman, et al., ANSI X9.31).

The flow shown in FIG. 12 begins with a step S1 which sets parameters such as “p” as a characteristic, “a” and “b” as elliptic curve coefficients (curve being expressed by y²=x³+ax+b), G as the base point on the elliptic curve, “r” as the order of G, and Ks as the secret key (0<Ks<r). Step S2 calculates the hash value of a message M, setting a parameter “f” as being f=Hash(M).

A description will now be given of the method for determining the hash value using a hash function. The hash function is a function which, upon receipt of a message, compresses the message into data of a predetermined bit length and then delivers an output as a hash value. The hash function has unique features that the input message can hardly be determined from the hash value as the output, and that it is difficult to determine different input data having an identical hash value. The hash function may be MD4, MD5, SHA-1 or the like, or DES-CBS may be used as the hash function. In this case, the MAC (check value: corresponding to 1 CV) as the final output provides the hash value.

In the subsequent step, Step S3, a random number u (0<u<r) is generated and, in Step S4, coordinates V (Xv, Yv) are determined by multiplying the coordinates of the base point with the random number “u”. Addition and doubling of values on elliptic curve are defined as follows:

It is assumed here that the following conditions are met:

P=(Xa, Ya), Q=(Xb, Yb), R=(Xc, Yc)=P+Q

When the condition is P≠Q: (addition)

Xc=λ²−Xa−Xb

Yc=λ×(Xa−Xc)−Ya

λ=(Yb−Ya)/(Xb−Xa)

When the condition is P=Q (doubling)

Xc=λ²−2Xa

Yc=λ×(Xa−Xc)−Ya

λ=(3(Xa)²+a)/(2Ya)

The coordinates of the point G are multiplied by “u”, using these definitions. A computing method which is most easy to understand, though the computation speed is low, is as follows. At first, G, 2×G, 4×G and so forth are calculated. The random number “u” is binarily expanded and 2ⁱ×G are determined for every “i” at which the expanded random number “u” is “1”. The value 2ⁱ×G is the value obtained by doubling G by “i” times, where the number “u” is the bit position as counted from the LSB of the random number “u”. Then, the values 2ⁱ×G are summed.

Step S5 calculates c=Xv mod r, and Step S6 determines whether this value is zero. If this value is not zero, the process proceeds to Step S7 which calculates d=[(f+cKs)/u] mod r and then Step S8 determines whether this value “d” is zero. If “d” is not zero, the process proceeds to Step S9 which outputs “c” and “d” as electronic signature data. When “r” has a length of 160 bits, the electronic signature data has a length of 320 bits.

If the number “c” is determined to be zero in Step S6, the process returns to Step S3 to restart generation of another random number. Likewise, restart from Step S3 is executed when the number “d” is determined as being zero in Step S8.

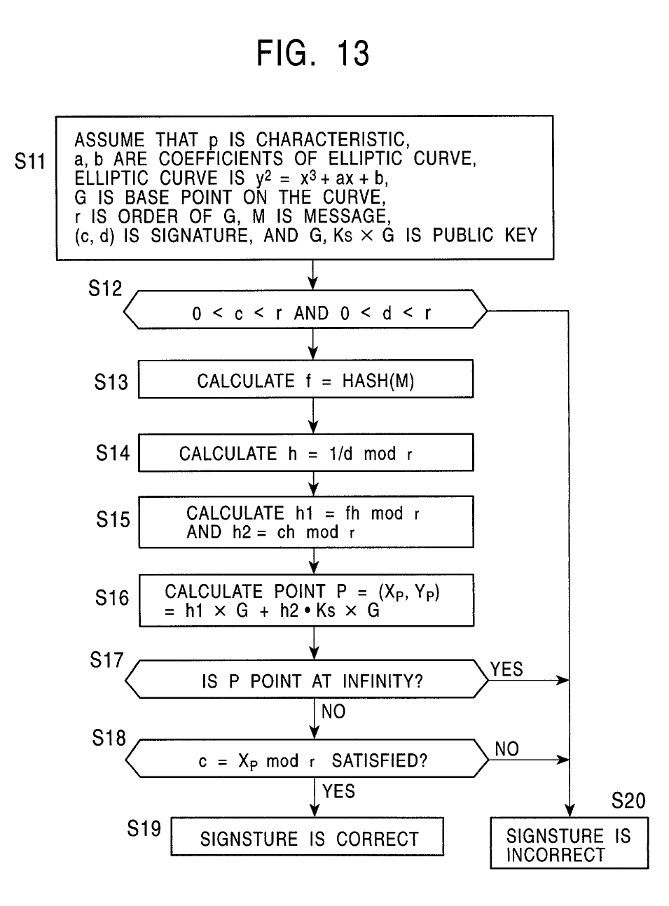

A description will now be given of a method of verification for verifying the electronic signature relying upon the public key cryptography, with specific reference to FIG. 13. In Step S11, parameters are set such as “M” as the message, “p” as a characteristic, “a” and “b” as elliptic curve coefficients (curve being expressed by y²=x³+ax+b), G as the base point on the elliptic curve, “r” as the order of G, and G and Ks×G as the secret key (0<Ks<r). Step S12 determines whether the electronic signature data “c” and “d” meet the conditions of 0<c<r and 0<d<r. If these conditions are met, the process proceeds to Step S13 that calculates the hash value of the message M to determine f=Hash (M). Step S14 calculates h=1/d mod r and Step S15 determines h1=fh mod r, and h2=ch mod r.

Step S16 computes the point P=(Xp, Yp)=h1×G+h2, Ks×G, using the values h1 and h2 calculated in the preceding step. The verifier of the electronic signature knows the public key G and Ks×G, so that it can calculate scholar multiple of a point on the elliptic curve as done in Step S4 of the flow shown in FIG. 12. Then, Step S17 determines whether the point P is a point at infinity and, if the point P is not a point at infinity, the process proceeds to Step S18. Actually, however, the determination as to whether the point P is at infinity can be done in Step S16. More specifically, the value “” cannot be calculated when executing the addition of P=(X, Y) and Q=(X, −Y), thus indicating that P+Q is a point at infinity. Step S18 calculates Xp mod r and compares the result with the electronic signature data “c”. If the calculation result conforms with the electronic signature data “c”, the process finally proceeds to Step S19 which determines that the electronic signature is a true one.

The fact that the electronic signature is true indicates that the data has not been interpolated, i.e., that the electronic signature has been legally executed by the party which possesses the secret key corresponding to the public key.

When the electronic signature “c” or “d” fails to meet the condition of 0<c<r or 0<d<r in Step S12, the process proceeds to Step S20. Step S20 is executed also when the value Xp mod r fails to coincide with the electronic signature data “c” in the comparison performed in Step S18.

Determination made in Step S20 that the electronic signature is not true indicates that the data has been interpolated or the signature has not been done by an entity that possesses a secret key corresponding to the public key.

[Mutual Authentication]

When data is exchanged between two means or entities, transmission of data is executed only after both entities have mutually confirmed that the opposite entity is a correct correspondent. Mutual authentication processing is executed to cause both entities involved in the data transmission to mutually confirm that the correspondents are authorized ones. In one preferred data transmission system, a session key is generated in the mutual authentication processing, and data is encrypted by using this session key as a common key, before the data transmission is started.

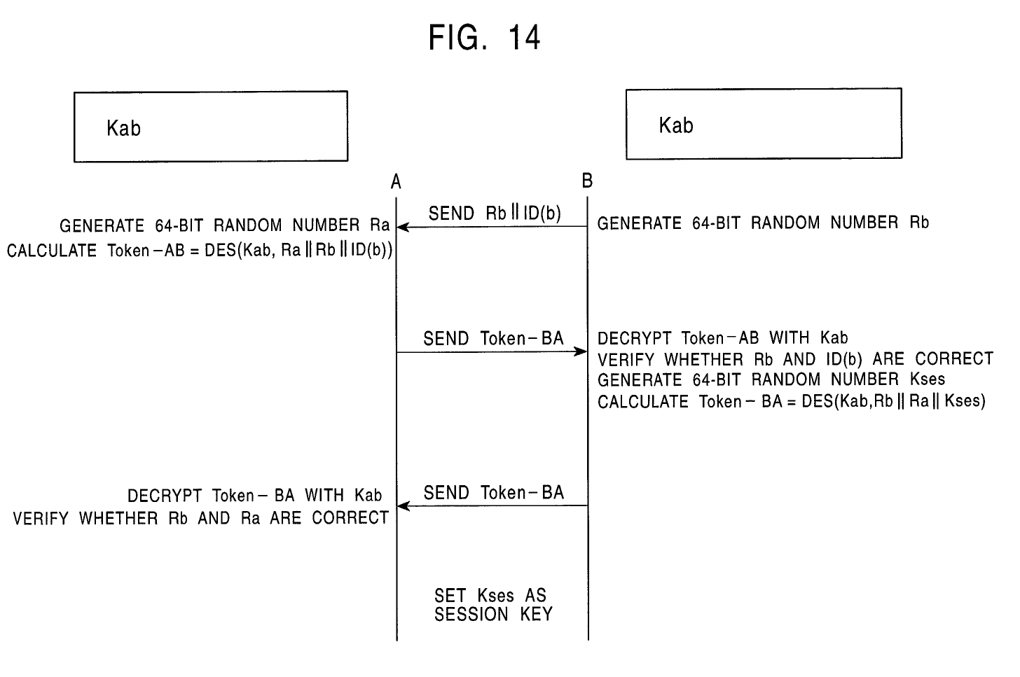

A description will be given of a mutual authentication method which uses the common key cryptography, with specific reference to FIG. 14. Although the example shown in FIG. 14 employs DES as the common key cryptography, other similar common key cryptographic key may be used equally well.

One of the two entities, the entity B in this case, generates a 64-bit random number Rb, and sends to the opposite entity A the generated random number Rb together with its identification number ID(b). Upon receipt of the random number Rb and the ID(b), the entity A generates a random number Ra, and performs encryption of data in the order of Ra, Rb and ID(b) in the CBC mode of DES using a key Kab. The entity A then sends back the encrypted data to the entity B.

Upon receipt of the encrypted data, the entity B decrypts the data by using the key Kab. The decryption of the received data has the steps of decrypting the encrypted text E1 by using the key Kab to determine the random number Ra, decrypting the encrypted text E2 by using the key Kab, determining exclusive OR of the text E1 and the result of the decryption of the text E2 to determine the random number Rb, decrypting the encrypted text E3 by using the key Kab, and determining exclusive OR of the text E2 and the decrypted text E3, whereby the ID(b) is determined. Then, a verification is executed to examine whether the Rb and the ID(b) obtained through the above-described process coincide with those sent from the entity B. If this verification successfully ends, the entity B recognizes the entity A as being a legal correct correspondent.

Subsequently, the entity B generates a session key (Kses) which is to be used after the authentication. This session key is generated by using a random number. Then, data is encrypted in the order of Rb, Ra and Kses, in the CBS mode of DES, using the key Kab. The entity B sends the resultant encrypted data to the entity A.

Upon receipt of the encrypted data, the entity A decrypts the data by using the key Kab. This decryption is executed in the same way as that executed by the entity B and, therefore, detailed description is omitted in regard to this decryption procedure. The entity A then verifies coincidence between the Rb and Ra obtained through the decryption and those which were sent from the entity A. If coincidence is confirmed, the entity A recognizes the entity B as being an authorized correct correspondent. After the mutual authentication is successfully achieved in the manner described, the session key Kses is used as the common key for secret communication.

When any illegality or discordance is found during the verification of received data, the processing is ceased as being unsuccessful.

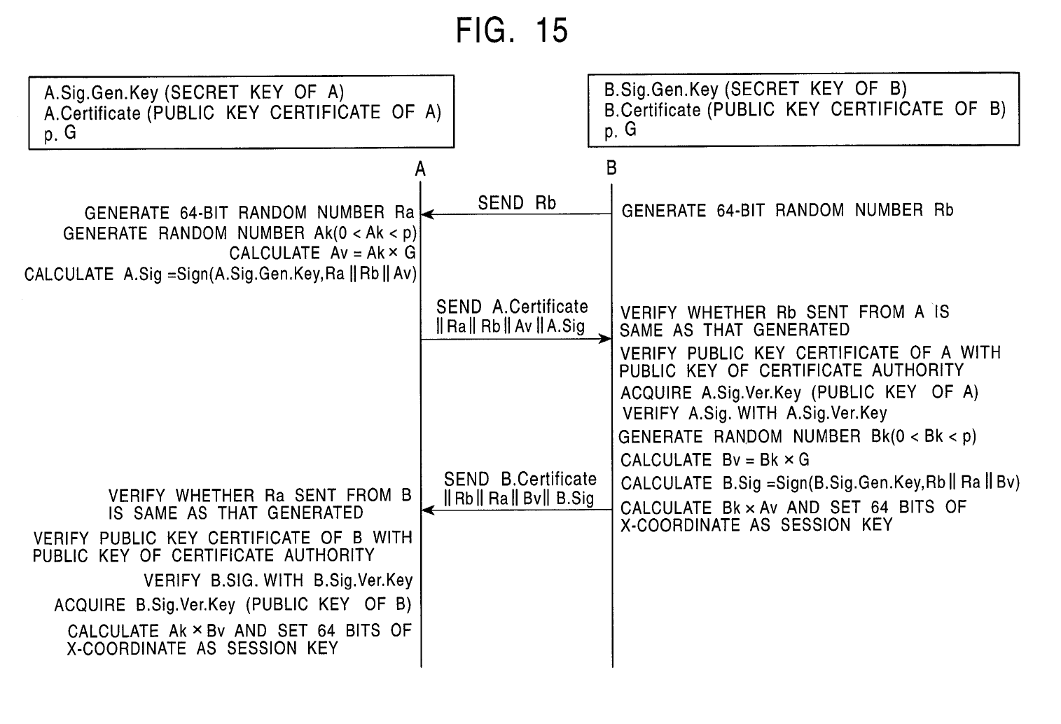

With reference to FIG. 15, a description will now be given of a mutual authentication method using a 160-bit elliptic curve cryptography which is a kind of public key cryptographic technique. Although the example shown in FIG. 15 employs ECC as the public key cryptography, other similar public key cryptography may be used equally well, as explained before. Likewise, the key length is not limited to 160 bits. Referring to FIG. 15, the entity B generates a 64-bit random number Rb and sends it to the entity A which in turn generates a random number Ra of 64 bits and a random number Ak which is smaller than the aforementioned characteristic “p”. The entity A then determines a point Av which is obtained by multiplying the base point G by Ak, i.e., Av=Ak×G. The entity A then generates an electronic signature A.Sig, corresponding to the Ra, Rb and Av (X- and Y-coordinates), and sends the signature to the entity B together with the public key certificate of the entity A. Since each of the random numbers Ra and Rb has a bit length of 64 bit, and since each of the X- and Y-coordinates of the Av has a length of 160 bits, the electronic signature formed by the entity A has the length of 448 bits in total. The method of generating the electronic key is the same as that described before with reference to FIG. 12, so that detailed description thereof is omitted.

A user when using the public key certificate verifies the electronic signature of the public key certificate by using a public key of the public key certificate issuer authority held by the user, and extracts and uses the public key from the public key certificate only after a successful verification of the electronic signature. Therefore, all the users who wish to use the public key certificate are required to hold a common public key of the public key certificate issuer authority. The method of verifying the electronic signature is not described in detail, because the verification can be done in the same method as that described before with reference to FIG. 13.

Referring back to FIG. 15, the entity B, which has received the public key certificate of the entity A together with the data Ra, Rb, Av and the electronic signature A.Sig, verifies whether the random number Rb received from the entity A is the same as that generated by the entity B. If the received random number Rb coincides with that generated by the entity B, the entity B verifies the electronic signature in the public key certificate of the entity A, by using the public key of the authentication authority and extracts the public key of the entity A. The entity B then verifies the electronic signature A.Sig by using the extracted public key of the entity A. The detail of the method of verifying the electronic signature is not described, because the verification can be done in the same way as that described before with reference to FIG. 13. Upon successful verification of the electronic signature, the entity B recognizes the entity A as being an authorized correct correspondent.

Subsequently, the entity B generates a random number Bk which is smaller than the characteristic “p”, and determines a point Bv which is the multiple of the base point G by Bk (Bv=Bk×G). Then, the entity B generates its electronic signature B.Sig on the data Rb, Ra, Bv (X- and Y-coordinates), and sends the electronic signature B.Sig to the entity A together with the public key certificate of the entity B.

The entity A, which has received the public key certificate of the entity B together with the data Ra, Rb, Av and the electronic signature B.Sig, verifies whether the random number Ra received from the entity B is the same as that generated by the entity A. If the received random number Ra coincides with that generated by the entity A, the entity A verifies the electronic signature in the public key certificate of the entity B, by using the public key of the authentication authority and extracts the public key of the entity B. The entity A then verifies the electronic signature B.Sig by using the extracted public key of the entity B. Upon successful verification of the electronic signature, the entity A recognizes the entity B as being an authorized correct correspondent.

When both entities have succeeded in the authentication, the entity B calculates Bk×Av. Although the Bk is a random number, a scholar multiplication calculation of a point on elliptic curve is necessary, because Av is a point on the elliptic curve. In the meantime, the entity A calculates Ak×Bv. The lower 64 bits of the X-coordinates of these calculated points are used as the session key for the subsequent communication. Such a bit length of the session key is used when the common key cryptography has a length of 64 bits. Thus, it is not always necessary that the session key is composed of the lower 64 bits. The secret communication after the mutual authentication is conducted by encrypting the transmission data by means of the session key, with or without electronic signatures attached to the data.

In the event that any illegality or discordance is found in the course of verification of the electronic signature or received data, the processing is ceased because of the unsuccessful mutual authentication.

Both entities then execute the data communication by encrypting and decrypting the data using the session key generated in the course of the mutual authentication processing.

[Issuance and Use of Access Permit]

(Description of Terms Used)

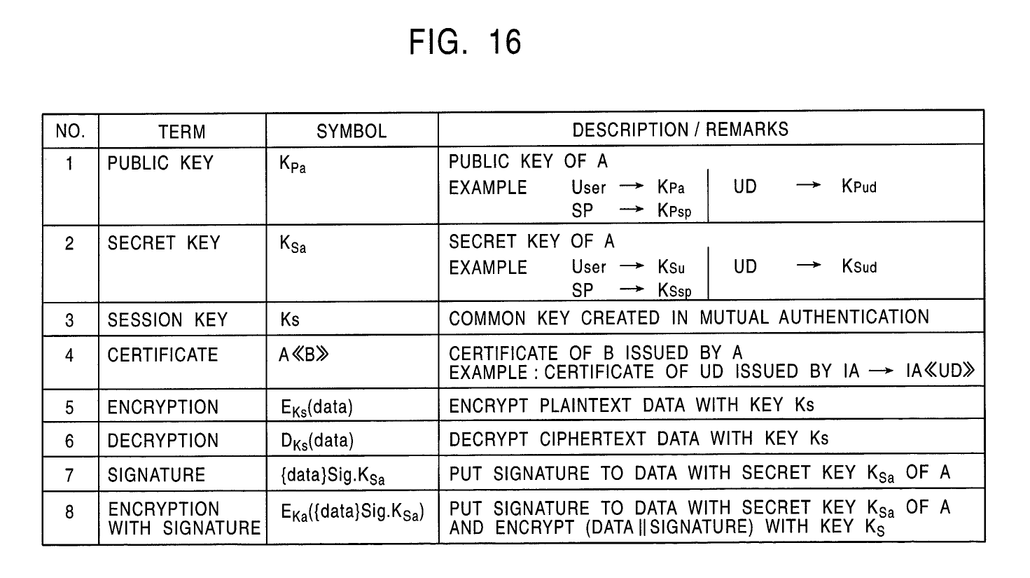

Next, a description is given of a process of issuing an access permit and a process of using it in sequence. An explanation of terms used in the following description is shown in FIG. 16. These terms will now be described briefly. The key is represented by K, P is added as a suffix to the public key, S is added to the secret key, and an owner identifier (for example, a) is added. A session key which is created during mutual authentication and used for encryption and decryption processes is represented by Ks. The public key certificate of B issued by A is represented as [symbol] [symbol] . As for encryption of data, for example, when data is encrypted using the session key Ks, this is indicated by E_{Ks} (data). Similarly, for decryption of data, this is shown as D_{Ks}(data). As for a signature process, when, for example, data is signed using a secret key Ksa, this is shown as {data} Sig·Ksa. Furthermore, as for encrypted data with a signature, when, for example, (data||signature) which is created by putting a signature on data using the secret key Ksa of A is encrypted using the session key Ks, this is indicated by E_{Ks}({data} Sig·Ksa).

(Process of Issuing First Access Permit with Respect to Device)

Next, a description is given of a processing sequence which obtains a first access permit, as a process for obtaining an access permit of a service provider by a user device, in the access control system of the present invention.

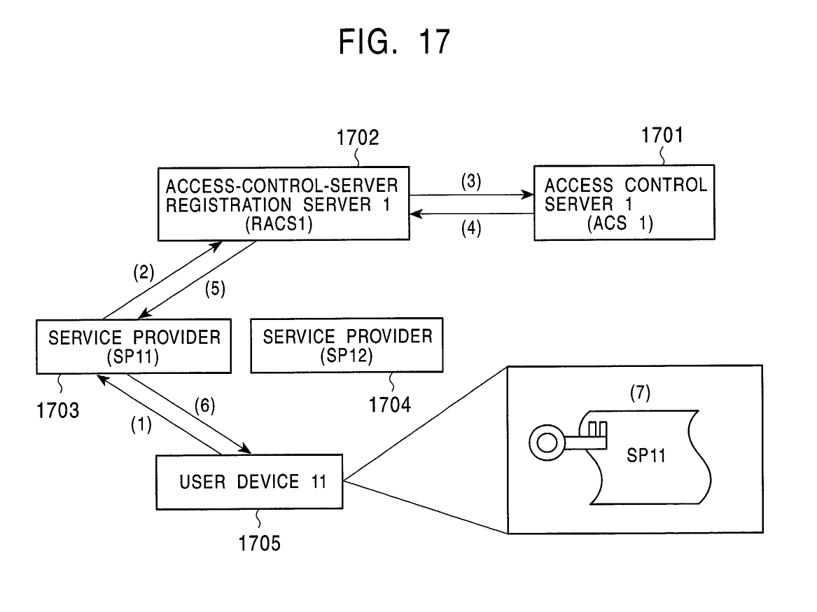

FIG. 17 shows a processing sequence in this case in accordance with a data transmission and receiving sequence between entities. The process of obtaining a first access permit proceeds in accordance with the number (n) shown in FIG. 17. Each process will be described below.

Initially, in a process (1), in order for a device 1705 to obtain a permit for receiving services of a service provider (SP11) 1703, the device 1705 creates data requested by the service provider (SP11) 1703, for example, user device ID, various pieces of user information such as age, and device information, and transmits it to the service provider. Before the data is transmitted, mutual authentication is performed between the device 1705 and the service provider (SP11) 1703, and a session key E_{Ks1} is created. The transmission data in the process (1) is data E_{Ks1}({UDID, data} Sig·K_{SUD}) which contains the user device ID (UDID) and other information (data) requested by the service provider 1703, on which a signature is put using a secret key K_{SUD} of the device 1705, and on which an encryption process is performed using the session key E_{Ks1}.

The service provider (SP11) 1703 decrypts the encrypted data received from the user device 1705 using the session key E_{Ks1}, and performs signature verification in order to examine the data contents. When the examination criteria requested by the service provider (SP11) 1703 are satisfied, the service provider (SP11) 1703 performs the process (2), that is, requests an access-control-server registration server (RACS1) 1702 to issue an access permit.

In this process (2), the service provider (SP11) 1703 transmits the described items of the option field in the access permit described above using FIG. 10 to the access-control-server registration server (RACS1) 1702. In this case, the items contain the “contents” data in accordance with one of the modes of FIG. 11. For example, in the case of the method A of FIG. 11, the service provider 1703 creates user information, and encrypts it using the key of the service provider 1703 as necessary in order to create transmission data. In the case of the method B of FIG. 11, only the user ID need only be created, and in the case of the method C of FIG. 11, a request for issuing the access permit need only be made. If the data created by the service provider (SP11) 1703 is denoted as (data2) and the session key which is created during a mutual authentication process between the service provider (SP1) 1703 and the access-control-server registration server (RACS1) 1702 as E_{Ks2}, the data to be transmitted in the process (2) is E_{Ks2} ({SPID, data2} Sig·K_{SSP}).

When the access-control-server registration server (RACS1) 1702 receives the data from the service provider (SP11) 1703, the access-control-server registration server (RACS1) 1702, based on the received data, makes a request for issuing an access permit to an access control server (ACS1) 1701 (process (3)).

Next, the access control server (ACS1) 1701, based on the request data, creates an access permit (ACPMS), and transmits data {ACPMS} Sig·K_{SACS1} on which the signature of the access control server (ACS1) 1701 is put to the access-control-server registration server (RACS1) 1702 (process (4)). When the data communication between the access control server (ACS1) 1701 and the access-control-server registration server (RACS1) 1702 is formed as secure communication in which external interruptions are eliminated, such as in privately used lines, the construction may be that in which data which is not particularly encrypted is transmitted and received. If the security of the communication line is not ensured, an encryption process using a session key is performed, and transmission and reception of data are performed in a manner similar to the communication between the other entities.

Next, the access-control-server registration server (RACS1) 1702 performs a signature verification process for the data received from the access control server (ACS1) 1701 in order to add its own signature thereto, and transmits data E_{Ks5}({ACPMS} Sig·K_{SRACS1}) K_{SRACS1}) to the service provider (SP11) 1703 (process (5)).

Next, the service provider (SP11) 1703 performs a signature verification process for the data received from the access-control-server registration server (RACS1) 1702, adds its own signature thereto, and transmits data E_{Ks6}({{{ACPMS} Sig·K_{SACS1}} K_{SRACS1}} K_{SSP}), which is encrypted using the session key, to the user device 1705 (process (6)).

After the decryption process using a session key E_{Ka4}, the user device 1705 performs signature verification, and stores the access permit (ACPMS) in its own secure module (process (7)). During the storage, preferably, an encryption process is performed using its own storage key Kₛₜᵣ.

(Process of Issuing New Access Permit when Device Already has Access Permit)

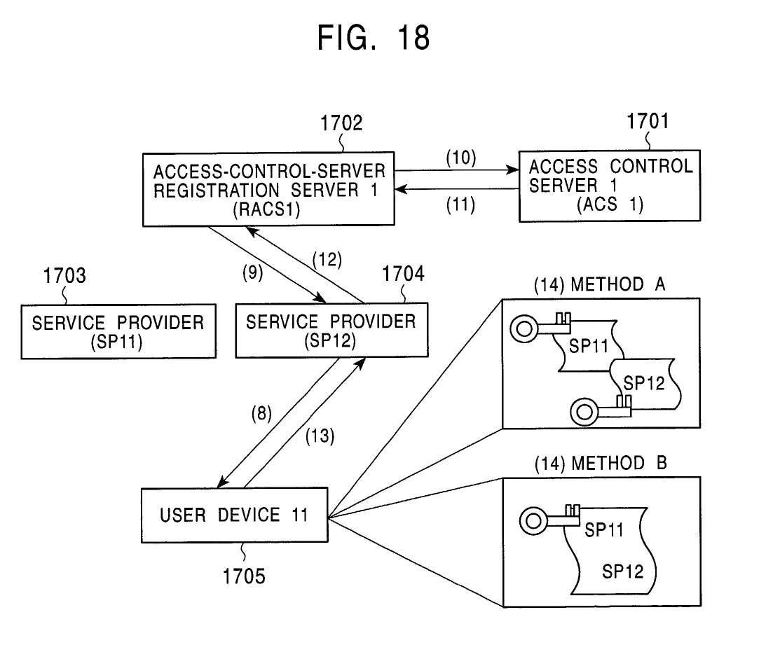

Next, referring to FIG. 18, a description is given of a process in a case where the user device already has an access permit of a particular service provider and an access permit of another service provider is to be newly obtained.

The user device 1705 shown in FIG. 18 already has an access permit of the service provider (SP11) 1703, and newly obtains an access permit of a service provider (SP12) 1704. Initially, the user device 1705 creates data requested by the service provider (SP12) 1704, for example, user device ID, various pieces of user information such as age, and device information, and transmits the data to the service provider (SP12) 1704 (process (8)). The transmission data at this time, in a manner similar to the above description using FIG. 17, is data E_{Ks8}({UDID, data} Sig·K_{SUD}), which contains user device ID (UDID) and other information (data) requested by the service provider (SP12) 1704 on which a signature using the session key E_{SUD} of the user device 1705 is put, and on which an encryption process is performed using the session key E_{Ks8}.

The service provider (SP12) 1704 decrypts the encrypted data received from the user device 1705 using the session key E_{Ks}, and performs signature verification in order to examine the data contents. When the examination criteria required by the service provider (SP12) 1704 are satisfied, the service provider (SP12) 1704 performs the process (9), that is, makes a request for issuing an access permit to the access-control-server registration server (RACS1) 1702.

In this process (9), the data to be transmitted is E_{Ks9}({SPID, data2} Sig·K_{SSP}) in a manner similar to the above-described process (2) of FIG. 17. When the access-control-server registration server (RACS1) 1702 receives the data from the service provider (SP12) 1704, the access-control-server registration server (RACS1) 1702, based on the received data, makes a request for issuing an access permit to the access control server (ACS1) 1701 (process (10)).

Next, the access control server (ACS1) 1701, based on the request data, creates an access permit (ACPMS), and transmits data {ACPMS} Sig·K_{SACS1} on which the signature of the access control server (ACS1) 1701 is put to the access-control-server registration server (RACS1) 1702 (process (11)). As for the access permit created by the access control server (ACS1) 1701, there is a plurality of methods, as described above with reference to FIGS. 9 and 10. For example, in the case in accordance with the method A of FIG. 9, it becomes an access permit for each service provider, and in this case, a new access permit which is effective for only the service provider (SP12) 1704 is issued. In the case in accordance with the method B of FIG. 9, an option field (see FIGS. 10 and 11) of the new service provider (SP12) 1704 is added to the existing access permit which is already possessed by the user device 1705, and a process of changing the existing access permit is performed.

Next, the access-control-server registration server (RACS1) 1702 performs a signature verification process for the data received from the access control server (ACS1) 1701, adds its own signature thereto, and transmits data E_{Ks12}({{ACPMS} Sig·K_{SACS1}} K_{SRACS1}), which is encrypted using the session key, to the service provider (SP12) 1704 (process (12)).

Next, the service provider (SP12) 1704 performs a signature verification process for the data received from the access-control-server registration server (RACS1) 1702, adds its own signature thereto, and transmits data E_{Ks13}({{{ACPMS} Sig·KSACS1} K_{SRACS1}} K_{SSP}), which is encrypted using the session key, to the user device 1705 (process (13)).

After the decryption process using the session key E_{Ks13}, the user device 1705 performs signature verification, and stores the access permit (ACPMS) in its own secure module. During the storage, preferably, an encryption process is performed using its own storage key Kₛₜᵣ. In the case of the method A, the access permit in this case becomes an access permit for each service provider, as shown in the upper part of FIG. 18. In the case of the method B, the access permit becomes an access permit which is common among a plurality of service providers, as shown in the lower part of FIG. 18.

(Use of Access Permit)

Next, a description is given of a process in which a user device uses an access permit in order to receive services from a service provider.

The user device first performs a mutual authentication process with a service provider from which provisions of services are to be received. When the mutual authentication is established and the session key E_{Ks} is created, the user device puts, using its own secret key, a signature on the access permit (ACPMS), and transmits data E_{Ks}({UDID, ACPMS} Sig·K_{SUD}), which is encrypted using the session key, to the service provider.

The service provider decrypts the received data using the session key E_{Ks}, performs a signature verification process, checks the access permit (ACPMS) in order to ascertain that it is a valid access permit, and permits access on condition that it is ascertained.

In the manner described above, according to the access control system of the present invention, for example, an access control server which is commonly used among a plurality of service providers is disposed, and access control is performed in accordance with the format and the procedure prescribed by the access control server. Therefore, it is not necessary for each service provider to construct an access control procedure of its own. Furthermore, also in each user device, since processing in accordance with a fixed sequence becomes possible without performing an access processing sequence in accordance with an individual service provider, it is not necessary to individually store and manage format data, access programs, etc., for each service provider.

(Process of Stopping Use of Access Permit)

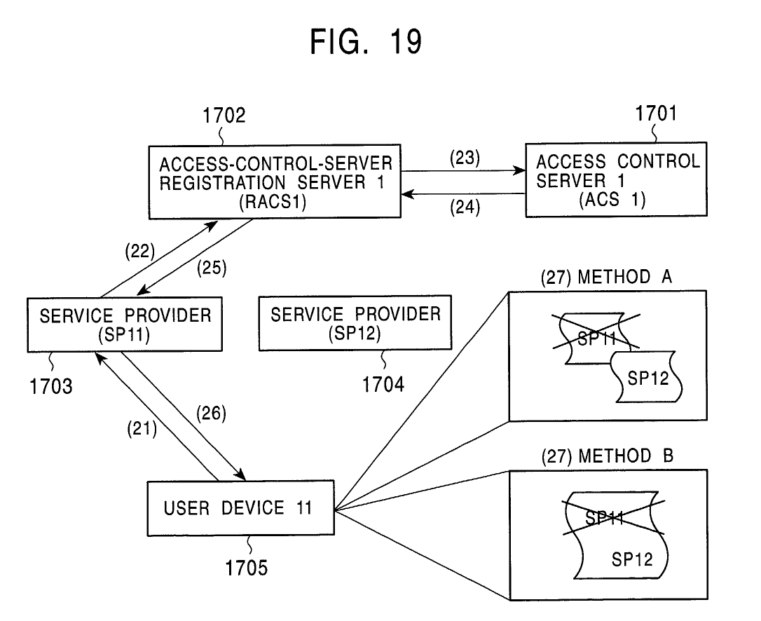

Next, referring to FIG. 19, a description is given of a process in a case where the user device stops receiving services from the service provider through the use of the access permit.

Initially, in the process (21), in order for the user device 1705 to perform a process for stopping services from the service provider (SP11) 1703, the user device 1705 creates data requested by the service provider (SP11) 1703 and transmits it to the service provider. The transmission data is data E_{Ks21}({UDID, data} Sig·K_{SUD}) which contains user device ID (UDID) and other information (data), requested by the service provider (SP11) 1703, on which a signature is put using the secret key K_{SUD} Of the user device 1705, and on which an encryption process is performed using the session key E_{Ks21}.

The service provider (SP11) 1703 decrypts the encrypted data received from the user device 1705 using the session key E_{Ks21}, performs signature verification, examine the data contents, and performs the process (22), that is, makes a request for deleting or changing the access permit to the access-control-server registration server (RACS1) 1702. This deletion or changing processing mode can be performed as a permit deletion process when the access permit is an access permit for each service provider of the method A described above with reference to FIG. 9. In the case of the method B, the deletion or changing processing mode can be performed as an access permit changing process. However, also in the case of the deletion, there are various access nonpermission modes, such as, for example, access being stopped for a fixed period of time or only limited use being possible, and a process for adding an identifier indicating access limitation to the permit is also possible without deleting the access permit itself. Accordingly, in the following, a description is given by assuming that the deletion of the access permit is also one mode of the changing process.

When the access-control-server registration server (RACS1) 1702 receives the above-described data from the service provider (SP11) 1703, the access-control-server registration server (RACS1) 1702, based on the received data, requests the access control server (ACS1) 1701 to perform a process of changing the access permit (process (23)).

Next, the access control server (ACS1) 1701, based on the request data, performs a process of changing the access permit (ACPMS), creates data in which the signature of the access control server (ACS1) 1701 is put on the changed access permit, and transmits it to the access-control-server registration server (RACS1) 1702 (process (24)).

Next, the access-control-server registration server (RACS1) 1702 performs a process of verifying the signature of the data received from the access control server (ACS1) 1701, adds its own signature thereto, and transmits the changed access permit which is encrypted using the session key to the service provider (SP1) 1703 (process (25)).

Next, the service provider (SP11) 1703 performs a process of verifying the signature of the data received from the access-control-server registration server (RACS1) 1702, adds its own signature thereto, and transmits the changed access permit which is encrypted using the session key to the user device 1705 (process (26)).

After the decryption process using the session key, the user device 1705 performs signature verification, and confirms the changed access permit. When there is valid data in the changed access permit, the user device 1705 stores it in its own secure module (process (27)).

(Process of Causing Access Permit to Become Invalid)

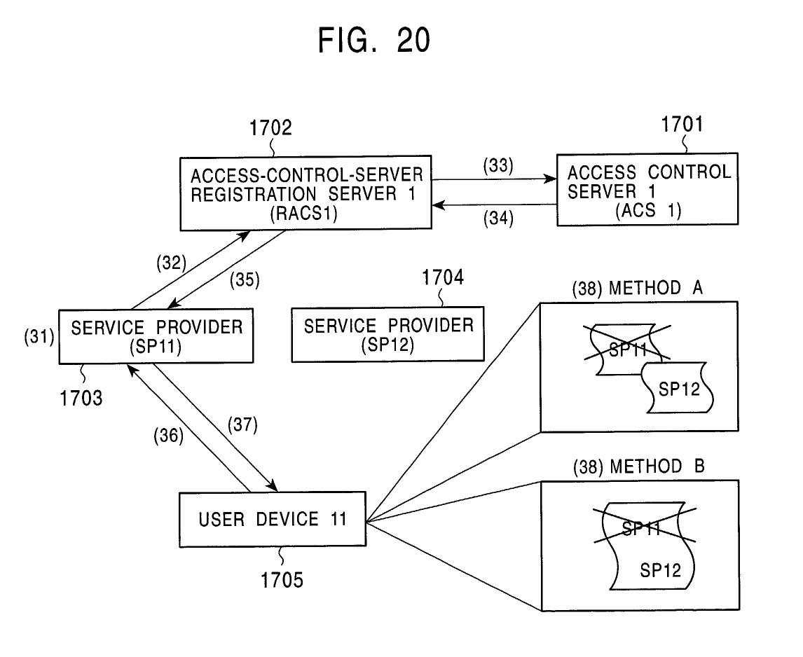

The above-described processing is a process in which the user device stops using the access permit on its own. Next, referring to FIG. 20, a description is given of a process in which the use of an access permit of a specific user is stopped, that is, the access permit is caused to become invalid from the service provider side.

Initially, when an unauthorized user is detected or it becomes clear that the access conditions of the user device are not satisfied, the service provider 1703 determines to perform a process of causing the access permit of the user to become invalid (process (31)).

The service provider (SP1) 1703 requests the access-control-server registration server (RACS1) 1702 to change the access permit (process (32)). When the access-control-server registration server (RACS1) 1702 receives the above-described data from the service provider (SP1) 1703, the access-control-server registration server (RACS1) 1702, based on the received data, requests the access control server (ACS1) 1701 to perform a process of changing the access permit (process (33)).

Next, the access control server (ACS1) 1701 performs a process of changing the access permit (ACPMS) based on the request data, creates data in which the signature of the access control server (ACS1) 1701 is put on the changed access permit, and transmits it to the access-control-server registration server (RACS1) 1702 (process (34)).

Next, the access-control-server registration server (RACS1) 1702 performs a process of verifying the signature of the data received from the access control server (ACS1) 1701, adds its own signature thereto, and transmits the changed access permit which is encrypted using the session key to the service provider (SP1) 1703 (process (35)).

After such processing, when there occurs an access request from the user device 1705 (process (36)), the service provider (SP11) 1703 transmits the changed access permit to the user device 1705 (process (37)). The user device 1705 confirms the changed access permit, and when there is a changed access permit containing valid data, the user device 1705 stores it in its own secure module (process (38)).

(Process of Causing Access Permit to Become Invalid by System Holder)

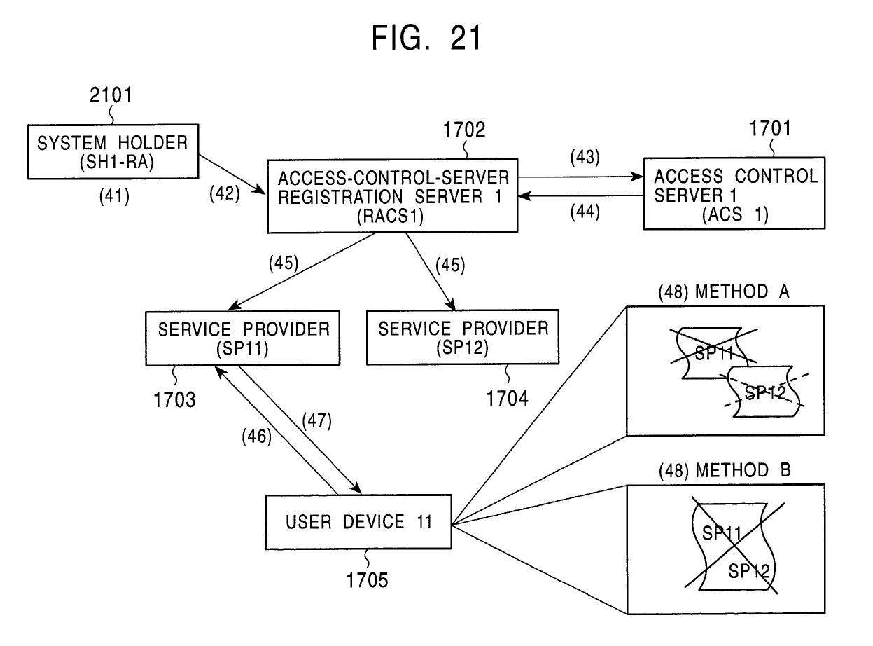

The above-described processing is a process in which the use of the access permit of a specific user is stopped from the service provider side, that is, the access permit is caused to become invalid from the service provider side. Next, referring to FIG. 21, a description is given of a process of causing an access permit to become invalid by the system holder.

Initially, when an unauthorized user is detected or it becomes clear that the access conditions of the user device are not satisfied, the system holder 2101 determines to perform a process of causing the access permit of the user to become invalid (process (41)).

The system holder 2101 makes a request of changing the access permit to the access-control-server registration server (RACS1) 1702 (process (42)). When the access-control-server registration server (RACS1) 1702 receives the above-described data from the system holder 2101, the access-control-server registration server (RACS1) 1702, based on the received data, makes a request of changing the access permit to the access control server (ACS1) 1701 (process (43)).

Next, the access control server (ACS1) 1701, based on the request data, performs a process of changing the access permit (ACPMS), creates data in which the signature of the access control server (ACS1) 1701 is put on the changed access permit, and transmits it to the access-control-server registration server (RACS1) 1702 (process (44)).

Next, the access-control-server registration server (RACS1) 1702 performs a process of verifying the signature of the data received from the access control server (ACS1) 1701, adds its own signature thereto, and transmits the changed access permit which is encrypted using the session key to the service provider (SP1) 1703 and the service provider (SP12) 1704 under the control thereof (process (45)).

After such processing, when there occurs an access request from the user device 1705, the service provider (SP11) 1703 transmits the changed access permit to the user device 1705 (process (47)). The user device 1705 confirms the changed access permit, and when there is a changed access permit containing valid data, the user device 1705 stores it in its own secure module (process (48)).

[Usage of Access Permit Among Other Entities]

In the above-described example, access control between the service provider and the user device has been described. The access permit can also be applied to access control between different entities such as the system holder and the service provider. Furthermore, the access permit can also be applied to access control between user devices. As a result of forming the construction in such a way that, for example, since an access permit in accordance with a fixed format is transmitted and received during access between devices, it is possible for each user device to obtain the information of the transmission party in accordance with the fixed format and to determine the access permission/ nonpermission in accordance with the access permit. The access permit in this case is formed in such a way that the option field of the access permit described in FIG. 10 is provided with a field which is set independently by the user device.

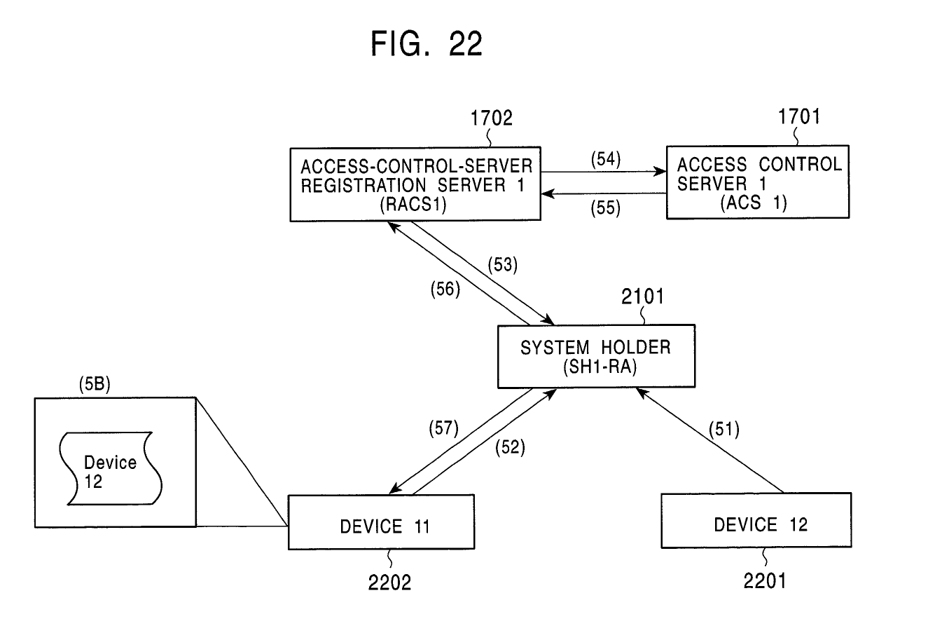

The usage of the access permit between devices will now be described with reference to FIG. 22. In FIG. 22, a device for providing services (service providing device) is set as a device 2201, and a device for receiving services (service receiving device) is set as a device 2202.

Initially, the device 2201 which is a service providing device requests the system holder 2101 to issue an access permit containing device information such that the device 2201 may provide services offline. The device 2201 makes a request of issuing an access permit in which device information such that the device 2201 may provide services offline is stored in the option field of the access permit for distribution between devices in a manner similar to that described in FIG. 10 (process (51)).

Furthermore, the device 2202 which is a service receiving device requests the system holder 2101 to issue an access permit for services which can be received offline by the device 2202 between devices (process (52)).

The system holder 2101 requests the access-control-server registration server (RACS1) 1702 to issue an access permit (process (53)). The access-control-server registration server (RACS1) 1702 requests the access control server (ACS1) 1701 to issue an access permit (process (54)).

Next, the access control server (ACS1) 1701, based on the request data, creates an access permit, and transmits the data in which the signature of the access control server (ACS1) 1701 is put, to the access-control-server registration server (RACS1) 1702 (process (55)). Next, the access-control-server registration server (RACS1) 1702 performs a process of verifying the signature of the data received from the access control server (ACS1) 1701, adds its own signature thereto, and transmits the data which is encrypted using the session key to the system holder 2101 (process (56)).

Next, the system holder 2101 performs a process of verifying the signature of the data received from the access-control-server registration server (RACS1) 1702, adds its own signature thereto, and transmits the data which is encrypted using the session key to the device 2202 (process (57)).

After the decryption process using the session key, the device 2202 performs signature verification, and stores the access permit in its own secure module (process (58)).

When the device 2202 which has received the access permit makes access to the device 2201, the device 2202 shows the access permit to the device 2201. Based on the shown access permit, the device 2201 becomes instantly possible to determine access permission/nonpermission.

Also for this access permit effective between devices, a service stopping process and an invalidation process are performed in a manner similar to the above-described process for the access permit of the service provider. However, the process of distributing the changed access permit is a distribution process from the system holder to a device. The timing at which the device is connected to the system holder is, for example, at the time of a process for updating a public key certificate, and the access permit which is updated at this time can be distributed.

However, the service providing device notifies the service receiving device of the fact that the access permit is updated, and the exchange of services between devices after the notification is performed on condition that the service receiving device is connected to the system holder, thereby making it possible to eliminate the use of an invalid access permit.

[Construction of Each Entity]

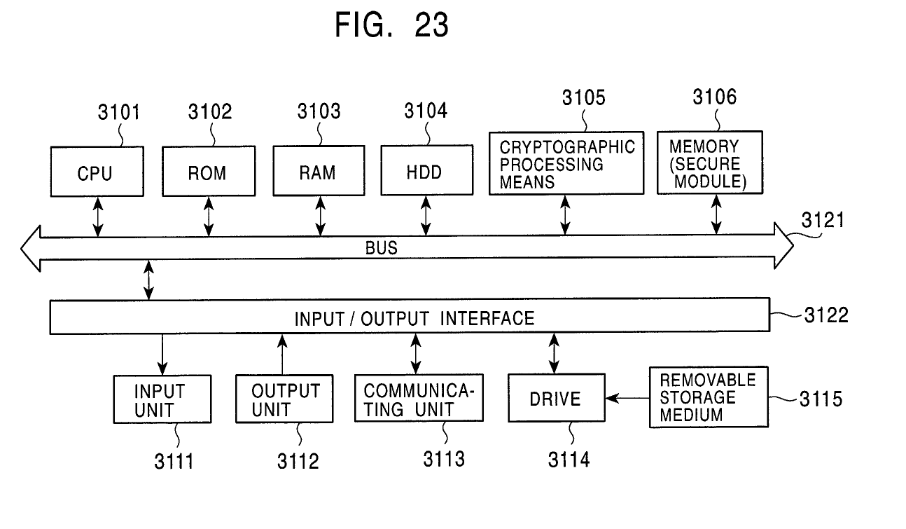

Next, an example of the construction of each entity which is a constituent of the above-described access control system will be described with reference to the figures. First, referring to FIG. 23, a description is given of an example of the construction of a user device as a service receiving device which receives services from a service provider based on an access permit.

The user device may be realized by data processing means, such as a PC, having communication means capable of performing communication with a service provider, etc. FIG. 23 shows an example of the construction of the device. The example of the construction of the device shown in FIG. 23 is only an example, and the device is not necessarily required to be provided with all the functions shown herein. A CPU (Central Processing Unit) 3101 shown in FIG. 23 is a processor which executes various application programs and the OS (Operating System). A ROM (Read-Only Memory) 3102 has stored therein programs to be executed by the CPU 3101 and fixed data as computation parameters. A RAM (Random Access Memory) 3103 is used as a storage area for programs to be executed in the processing of the CPU 3101 and parameters which change as appropriate in program processing and as a work area therefor.

A hard disk drive (HDD) 3104 performs the control of a hard disk so that a process of storing various types of data and programs in the hard disk and a process of reading them are performed. Encryption processing means 3105 performs a process of encrypting transmission data and a decryption process. Here, although an example is shown in which the encryption processing means is used as an individual module, such an independent encryption processing module need not be provided and, for example, an encryption processing program may be stored in the ROM 3102 and the CPU 3101 may read the program stored in the ROM and executes it. A memory (secure module) 3106 is formed as, for example, a memory having an anti-tampering structure, and can be used as a storage area for key data and an access permit which are necessary for an encryption process. The data may also be stored in another memory area or storage medium.

A bus 3121 is formed of a PCI (Peripheral Component Interconnect) bus, etc., so that data transfer to and from each input/output device via each module and an input/output interface 3122 is made possible.

An input section 3111 is formed of, for example, a keyboard, a pointing device, etc., and is operated by a user in order to input various commands and data to the CPU 3101. An output section 3112 is, for example, a CRT, a liquid-crystal display, etc., and displays various information in the form of text, an image, etc.

A communication section 3113 performs a communication process with an entity to which a device is connected, for example, a service provider, and performs a process for transmitting data supplied from each storage section, data processed by the CPU 3101, encrypted data, or the like, and for receiving data from another entity under the control of the CPU 3101.

A drive 3114 is a drive for performing recording onto and reproduction from a removable recording medium 3115 such as a floppy disk, a CD-ROM (Compact Disk-Read Only Memory), an MO (Magneto-optical) disk, a DVD (Digital Versatile Disk), a magnetic disk, a semiconductor memory, etc. The drive 3114 reads a program or data from each removable recording medium 3115 and stores a program or data in the removable recording medium 3115.

When the program or the data recorded in each recording medium is to be read, and executed or processed by the CPU 3101, the read program or data is supplied to, for example, the connected RAM 3103 via the interface 3122 and a bus 3121.

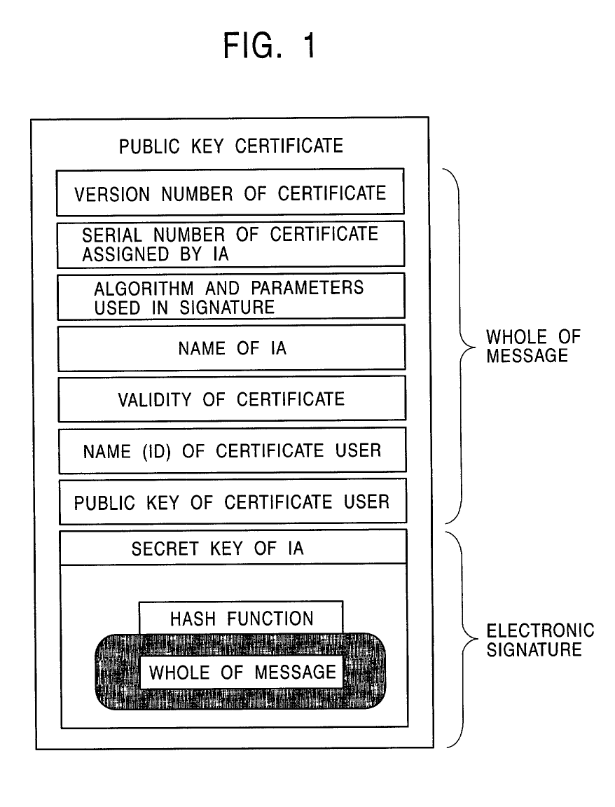

A program for executing a process in the user device, included in the above description provided with reference to FIGS. 1 to 22 is, for example, stored in the ROM 3102 and is processed by the CPU 3101, or the program is stored in the hard disk, and is supplied to the CPU 3101 via the HDD 3104 and is executed thereby.

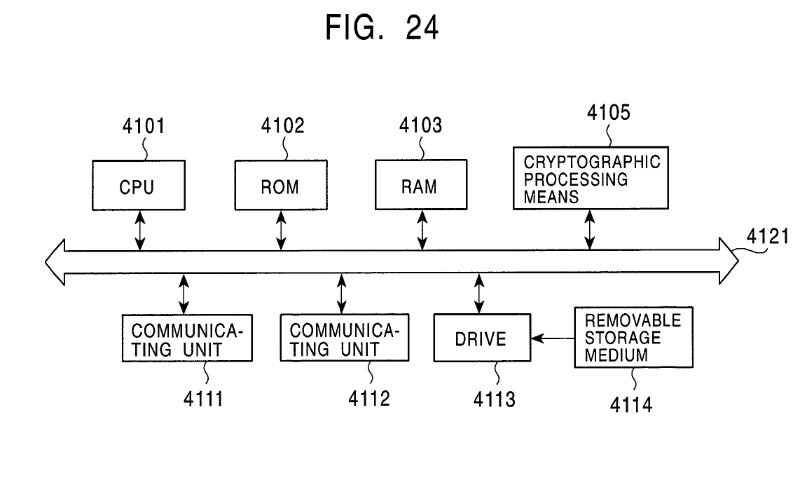

Next, a description is given of an example of the construction of a data processing apparatus which constitutes an access control server, an access-control-server registration server, and a service provider, which are entities forming the access control system of the present invention. These entities can be realized by the construction shown in, for example, FIG. 24. The example of the construction of a data processing apparatus which constitutes an access control server, an access-control-server registration server, and a service provider, shown in FIG. 24, is only an example, and each of these entities is not necessarily required to be provided with all the functions shown herein.

A CPU (Central Processing Unit) 4101 shown in FIG. 24 actually executes various application programs and the OS (Operating System). A ROM (Read-Only Memory) 4102 has stored therein programs to be executed by the CPU 4101 or fixed data as computation parameters. A RAM (Random Access Memory) 4103 is used as a storage area for programs to be executed in the processing of the CPU 4101 and parameters which change as appropriate in program processing and used as a work area therefor. A hard disk drive (HDD) 4104 performs the control of a hard disk so that a process of storing various types of data and programs in the hard disk and a process of reading them therefrom are performed. Encryption processing means 4105 performs a process of encrypting transmission data and a decryption process, etc. Here, although an example is described in which the encryption processing means is used as an individual module, the construction may be formed in such a way that such an independent encryption processing module is not provided, for example, an encryption processing program is stored in the ROM 4102 and the CPU 4101 reads the program stored in the ROM and executes it.

A drive 4113 is a drive for performing recording onto and reproduction from a removable recording medium 4114 such as a floppy disk, a CD-ROM (Compact Disk-Read Only Memory), an MO (Magneto-optical) disk, a DVD (Digital Versatile Disk), a magnetic disk, a semiconductor memory, etc. The drive 4113 reads a program or data from each removable recording medium 4114 and stores a program or data in the removable recording medium 4114. When the program or the data recorded in each storage medium is to be read, and is executed or processed by the CPU 4101, the read program or data is supplied to, for example, the RAM 4103, the communication section 4111, and the communication section 4112, which are connected, via a bus 4121.

As for the communication section 4111 and the communication section 4112, an example is shown in which a plurality of communication sections are provided by assuming a process in which communication is performed by considering an entity different for each to be a communication party. For example, in the case of the service provider, one of them is used for communication with the user device, and the other is used for communication with the access control server. Mutual authentication with a communication party, a transmission/receiving process for encrypted data, etc., are performed via each communication section.

A program for executing each process in a data processing apparatus which constitutes an access control server, an access-control-server registration server, and a service provider, which are entities forming the access control system included in the description with reference to FIGS. 1 to 22, is stored in, for example, the ROM 4102 and is processed by the CPU 4101, or the program is stored in a hard disk, is supplied to the CPU 4101 via the HDD 4104, and is executed thereby.

The series of processing described in the specification can be performed by hardware or software, or by a combination of both. In a case where the series of processing is to be performed by software, a program in which a processing sequence is recorded is installed into a memory within a computer incorporated into dedicated hardware and is executed, or the program is installed into a general-purpose personal computer capable of executing various processing and is executed.

For example, the program may be prerecorded in a hard disk as a recording medium or in a ROM (Read Only Memory). Alternatively, the program may be stored (recorded) temporarily or permanently in a removable recording medium, such as a floppy disk, a CD-ROM (Compact Disk-Read Only Memory), an MO (Magneto-optical) disk, a DVD (Digital Versatile Disk), a magnetic disk, or a semiconductor memory. Such a removable recording medium may be provided as what is commonly called packaged software.

In addition to being installed into a computer from the removable recording medium such as that described above, a program may be transferred in a wireless manner from a download site or may be transferred by wire to a computer via a network, such as the Internet, and in the computer, the program which is transferred in such a manner may be received and installed into a recording medium such as a hard disk contained therein.

Various processes described in this specification may be performed not only in a time-series manner along the described sequence, but also performed in parallel or individually according to the processing performance or the necessity of the apparatus which performs the process. Furthermore, in this specification, the system represents a logical assembly of a plurality of apparatuses, and the apparatus of each construction is not necessarily housed in the same housing.

As has thus been described, according to the access control system of the present invention, an access control server which is commonly used among a plurality of service providers and devices is disposed, and access control is performed in accordance with the format and the procedure prescribed by the access control server. As a result, it is not necessary for each service provider and each device to construct their own access control procedure, and it becomes possible to easily perform access control. Furthermore, also in a user device which receives services, since processing in accordance with a fixed sequence becomes possible without performing an access processing sequence in accordance with an individual service provider, it is not necessary to individually store and manage format data, an access program, etc., for each service provider.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

What is claimed is:

1. An access control system for use in a data transfer system which transfers data by means of public-key cryptosystem based on a public key certificate issued to an authentication object by a public key issuer authority, the access control system comprising:
a service provider which is an authentication object and which provides services;
a service receiving device which also is an authentication object and which receives services provided by the service provider; and
an access control server which issues to the service receiving device an access permission which identifies a service provider an access to which by the service receiving device is permitted;
wherein the service provider performs, based on the access permission, a decision as to whether an access request by the service receiving device is to be permitted.

2. An access control system according to claim 1, further comprising:
an access-control-server registration server,
wherein the access-control-server registration server is configured to execute a processing for requesting the access control server to execute issuance of the access permission, upon receipt of an access permission issuance request from the service receiving device.

3. An access control system according to claim 1, further comprising:
at least one system holder which is an organization that provides or controls contents usable by a user terminal, contents which enables provision of services, or a service distribution infrastructure;
wherein the system holder is configured to administrate the service provider and the service receiving device and to treat the service provider and the service receiving device as authentication objects.

4. An access control system according to claim 3, wherein a plurality of the system holders are provided, and wherein the access control server is provided for each of the system holders and is configured to issue the access permission in regard to the services provided by the service provider administrated by the system holder.

5. An access control system according to claim 3, wherein a single access control server is provided commonly for a plurality of system holders, and is configured to issue access permissions in regard to the services provided by the service providers administrated by the plurality of system holders.

6. An access control system according to claim 3, further comprising a root registration authority which administrates the system holder, wherein the root registration authority is configured to execute, based on a request from the system holder, a processing to request the public key certificate issuer authority to issue the public key certificates of the authentication objects administrated by the root registration authority.

7. An access control system according to claim 1, wherein the access control server generates the access permissions in a form independently usable for each of the service providers.

8. An access control system according to claim 1, wherein the access control server generates the access permission in a form commonly usable for a plurality of service providers.

9. An access control system according to claim 1, wherein the access control server is configured to generate the access permission in a format which comprises:
an access-control-server-set fixed field set by the access control server;
a service-provider-set option field set by each of the service providers; and
an electronic signature field to be performed by the access control server.

10. An access control system according to claim 9, wherein the service-provider-set option field includes identification data which indicates for each of the service receiving devices whether an access by the service receiving device is permitted, and wherein the identification data includes at least one of personal information concerning the user of the associated service receiving device, user ID, user device ID, and an access permission discrimination flag.

11. An access control system according to claim 1, wherein the data transfer between the service provider, the service receiving device and the access control server, performed directly or indirectly through an intermediary, is executed on condition that mutual authentication has been established between the sender of the data and the receiver of the data.

12. An access control system according to claim 1, wherein the data transfer between the service provider, the service receiving device and the access control server, performed directly or indirectly through an intermediary, transfers the data with an electronic signature of the sender added thereto.

13. An access control system according to claim 1, wherein the service provider is a device which provides a service.

14. An access control system according to claim 1, wherein the access control server is configured to execute an access permission changing processing for revocation of the permission set on the access permission.

15. An access control method for use in a data transfer system which transfers data by means of public-key cryptosystem based on a public key certificate issued to an authentication object by a public key issuer authority, the access control method comprising the steps of:
receiving, at a service provider, an access permission from a service receiving device, the access permission having been issued by a service control server; and
executing, based on the access permission, a determination as to whether access requested by the service receiving device is to be permitted.

16. An access control method according to claim 15, further comprising:
an access permission issuing step for issuing, at an access control server, an access permission which is delivered to the service receiving device and which enables identification of the service provide an access to which is permitted by the service receiving device.

17. An access control method according to claim 15, further comprising the steps of:
receiving, at an access-control-server registration server, the access permission issuance request from the service receiving device and requesting, at the access-control-server registration server, the access control server to execute the processing for issuing an access permission.

18. An access control method according to claim 15,
wherein the access permission issuing step is executed based on an issuance request from a service provider which is under the administration of a system holder as an organization that provides or controls contents usable by a user terminal, contents which enables provision of services, or a service distribution infrastructure.

19. An access control method according to claim 15, wherein the access permission issuing step generates the access permissions in a form independently usable for each of the service providers.

20. An access control method according to claim 15, wherein the access control server generates the access permission in a form commonly usable for a plurality of service providers.

21. An access control method according to claim 15, wherein the access permission issuing step generates the access permission of a format which comprises:
an access-control-server-set fixed field set by the access control server;
a service-provider-set option field set by each of the service providers; and
an electronic signature field to be performed by the access control server.

22. An access control method according to claim 15, wherein the step executed by the service provider for determining whether the access is to be permitted is executed based on identification data which determines whether the access is to be permitted for each of the service receiving devices and which is contained in the access permission, the identification data including at least one of personal information concerning the user of the associated service receiving device, user ID, user device ID, and an access permission discrimination flag.

23. An access control method according to claim 15, wherein the data transfer between the service provider, the service receiving device and the access control server, executed directly or indirectly through an intermediary, is executed on condition that mutual authentication has been established between the sender of the data and the receiver of the data.

24. An access control method according to claim 15, wherein the data transfer between the service provider, the service receiving device and the access control server, executed directly or indirectly through an intermediary, transfers the data with an electronic signature of the sender added thereto.

25. An access control method according to claim 15, further comprising an access permission changing processing executed by the access control server to revoke the permission set on the access permission.

26. A device having a data processing function, comprising:
communication processing means for executing data transfer processing;
cryptographic processing means for executing cryptographic processing on data; and
data storage means;
wherein the data storage means stores an access permission containing service provider identification data which identifies the service provider an access to which by a device ha been permitted;
the cryptographic processing means executes an electronic signature on the access permission; and
a processing for sending the access permission with the electronic signature is executed via the communication processing means.

27. A device according to claim 26, wherein the access permission is a permission which is issued by an access control server that executes administration of control of access by the device to the service provider, and
wherein the device is configured to execute, by the cryptographic processing means, a processing for verifying the signature made by the access control server and added to aid access permission.

28. A device according to claim 26, wherein the device is configured to store in the data storage means one or more access permissions each containing service provider identification data for a single service provider, or an access permission containing service provider identification data for a plurality of service providers, and to send, through the communication processing means, an access permission selected based on the access destination.

29. A device according to claim 26, wherein the device is configured to execute mutual authentication between the device and the service provider to which the access permission is directed and to execute, on condition of the establishment of the authentication, a processing for encrypting the access permission with the electronic signature executed thereon and sending the encrypted access permission to the service provider.

30. An access control server which executes a processing for issuing an access permission which indicates that a device is permitted to access a service provider, the access control server comprising:
communication processing means for executing data transfer processing; and
cryptographic processing means for executing cryptographic processing of data;
wherein the access control server is configured to execute: a processing for receiving, through a service provider, an access permission issuance request given by a device which requests an access to the service provider;
and a processing for issuing an access permission which contains, at least, data concerning whether the device is permitted to access the service provider and an electronic signature executed by the access control server.

31. An access control server according to claim 30, wherein the access control server is configured to execute a processing for verifying the electronic signature of the sender added to the access permission issuance request, and to execute the processing for issuing the access permission on condition that the verification of the electronic signature has been successfully achieved.

32. An access control server according to claim 30, wherein the access control server is configured to execute a processing for mutual authentication between the access control server and the entity which is the sender of the access permission issuance request, and to execute a processing for receiving the access permission issuance request on condition that the mutual authentication has been established.

33. An access control server according to claim 30, wherein the access control server is configured to execute, when executing the processing for issuing the access permission, a processing for mutual authentication between the access control server and the entity which is the sender of the access permission issuance request, and to execute a processing for encrypting the access permission and sending the encrypted access permission to the entity, on condition that the mutual authentication has been established.

34. An access control server according to claim 30, wherein the access control server is configured to execute a processing for generating and issuing an access permission containing service provider identification data for a single service provider, or an access permission containing service provider identification data for a plurality of service providers.

35. An access-control-server registration server which executes a processing for sending a request to an access control server requesting issuance of an access permission, the access control server being responsible for executing a processing for issuing an access permission indicating that a device is permitted to access a service provider, comprising:
communication processing means for executing data transfer processing; and
cryptographic processing means for executing cryptographic processing of data;
wherein the access-control-server registration server receives, through a service provider, an access permission issuance request given by a device which requests an access to the service provider;
and wherein the access-control-server registration server further executes, upon receipt of the access permission issuance request, a processing for executing an electronic signature and then executes a processing for requesting the access control server to issue the access permission.

36. An access-control-server registration server according to claim 35, wherein the access-control-server registration server is configured to execute:
a processing for receiving the access permission issued by the access control server;
a processing for verifying the signature of the access control server that has been added to the received access permission; and
a processing for sending the received access permission to the service provider, after adding a signature of the access-control-server registration server to the access permission.

37. An access-control-server registration server according to claim 35,
wherein the access-control-server registration server is configured to execute:
a mutual authentication processing between the access-control-server registration server and an entity which is the sender of the access permission issuance request, and a processing for receiving the access permission issuance request on condition that the authentication has been achieved.

38. A data processing apparatus serving as a service provider which accepts accesses from a plurality of devices and which provides services in response to the accesses, the data processing apparatus comprising:
communication processing means for executing a data transfer processing; and
cryptographic processing means for executing a cryptographic processing on data;
wherein the data processing apparatus is configured to execute:
a processing for receiving, from the device, an access permission accommodating a service provider identification data that identifies the service provider to which the device has been permitted to make an access; and
a processing for determining, based on the data contained in the received access permission, whether the device is to be permitted to make an access.

39. A data processing apparatus according to claim 38, wherein the access permission is a permission which has been issued by the access control server in response to the access permission issuance request sent from the service provider and to which an electronic signature has been added by the access control server; and
wherein the data processing apparatus serving as the service provider is configured to execute a processing for verifying the electronic signature on the access permission received from the device, and a processing for permitting the device to make the access, upon confirming, through the verification, that the access permission is a true permission issued by the access control server.

40. A data processing apparatus according to claim 38, wherein the data processing apparatus serving as the service provider is configured to execute:
a mutual authentication processing between the data processing apparatus and the device, and a processing for receiving the access permission issuance request.

41. A data processing apparatus according to claim 38, wherein the data processing apparatus serving as the service provider is configured to execute, when conducting the processing for transferring the access permission to said device:
a mutual authentication processing between the data processing apparatus and the device, and a processing for sending, on condition of establishment of the authentication, the access permission, after addition of a signature of the service provider and an encryption of the access permission.

42. A program storage medium which provides a computer program that runs on a computer system to implement an access control processing in a data transfer system which transfers data by means of public-key cryptosystem based on a public key certificate issued to an authentication object by a public key issuer authority, the computer program comprising the steps of:
receiving, at a service provider, an access permission from a service receiving device, the access permission having been issued by a service control server; and
executing, based on the access permission, a determination as to whether access requested by the service receiving device is to be permitted.
